(19) United States
(12) Patent Application Publication
(10) Pub. No.: US 2024/0240794 A1
(43) Pub. Date: Jul. 18, 2024

(54) THREE-DIMENSIONAL FLAME GENERATION FOR ELECTRIC FIREPLACE

(71) Applicant: Greentouch USA, Inc., Miami Beach, FL (US)

(72) Inventor: Matthew Alfred Crowe, Dongguan City (CN)

(21) Appl. No.: 18/563,187

(22) PCT Filed: May 25, 2022
(86) PCT No.: PCT/US22/30835

§ 371 Date: Nov. 21, 2023

Related U.S. Application Data
(60) Provisional application No. 63/192,792, filed on May 25, 2021.

(51) Int. Cl. F24C 7/00; F21S 10/04

(52) U.S. Cl. CPC F24C 7/004; F21S 10/04

(57) ABSTRACT

An electric fireplace (10) includes a log assembly (319) and a flame generator (324). The flame generator (324) directs light away from the log assembly (319) in both a first direction (318A) and a second direction (318B) that is different from the first direction (318A) to generate a three-dimensional simulated flame (318).

### RELATED APPLICATIONS

This application claims priority on U.S. Provisional Application Ser. No. 63/192,792, filed on May 25, 2021, and entitled “THREE-DIMENSIONAL FLAME GENERATION FOR ELECTRIC FIREPLACE”. As far as permitted, the contents of U.S. Provisional Application Ser. No. 63/192,792 are incorporated in their entirety herein by reference.

Additionally, U.S. Provisional Application Ser. No. 63/192,792 is related to U.S. patent application Ser. No. 16/714,310, entitled “MODULAR ASSEMBLY FOR ELECTRIC FIREPLACE”, filed on Dec. 13, 2019. As far as permitted, the contents of U.S. patent application Ser. No. 16/714,310 are incorporated in their entirety herein by reference.

### BACKGROUND

Fireplaces of various types can be installed in homes and commercial establishments as a means to provide a source of heat and for aesthetic reasons. Although traditionally such fireplaces have most often taken the form of wood-burning fireplaces and gas-burning fireplaces, electric fireplaces have become increasingly popular in recent years. An electric fireplace is typically designed to look like a traditional wood-burning fireplace, but does not actually burn wood. As such, there is a continuing desire to make electric fireplaces look more realistic, i.e. to make electric fireplaces look more like a traditional wood-burning fireplace.

Unfortunately, in most currently available electric fireplaces, the electric fireplace includes a flame generator for generating a simulated flame where the simulated flame does not look realistic and/or where the flame generator is overly complex in design and implementation. Accordingly, there is a desire to provide a flame generator that generates a simulated flame within an electric fireplace that looks realistic (e.g., is fully three-dimensional) and that is relatively simple in design and implementation.

### SUMMARY

The present invention is directed toward an electric fireplace including a log assembly and a flame generator. In various embodiments, the flame generator directs light away from the log assembly in both a first direction and a second direction that is different from the first direction to generate a three-dimensional simulated flame.

In one embodiment, the log assembly includes at least one simulated log.

In other embodiments, the log assembly includes a plurality of simulated logs. In some such embodiments, the plurality of simulated logs are positioned relative to one another to define an assembly opening. In such embodiments, the light being directed in the first direction includes light being directed through the assembly opening. In one embodiment, the assembly opening is configured such that the first direction includes an angular range of between approximately 15 degrees and 45 degrees within which the light is directed through the assembly opening. In other such embodiments, the log assembly further defines at least a portion of a second assembly opening. In such embodiments, the light being directed in the second direction includes light being directed through the second assembly opening. In one embodiment, the second assembly opening is configured such that the second direction includes a second angular range of between approximately 25 degrees and 80 degrees within which the light is directed through the second assembly opening.

In certain embodiments, the flame generator includes a generator light source that generates flame light, and a reflective element that alternatively directs the flame light from the generator light source in both the first direction and the second direction. In some such embodiments, the reflective element can be rotated with an element mover to alternatively direct the flame light from the generator light source in both the first direction and the second direction. In some embodiments, the reflective element includes a substantially cylindrical tube-shaped base. Additionally, in certain embodiments, the reflective element can include a plurality of reflective surfaces.

In some embodiments, the electric fireplace further includes a grate that is configured to support the log assembly. In one such embodiment, the flame generator is incorporated into the grate. Additionally, the log assembly can be fixedly secured to the grate.

In certain embodiments, the electric fireplace further includes a controller including a processor that is configured to control operation of the flame generator.

In some embodiments, the controller is configured to control at least one of a timing, a pulsing and a magnitude of the light being directed by the flame generator.

Additionally, the present invention is further directed toward a method for manufacturing an electric fireplace. In one embodiment, the method includes providing a log assembly; and directing light away from the log assembly with a flame generator in both a first direction and a second direction that is different from the first direction to generate a three-dimensional simulated flame.

In certain embodiments, the present invention is further directed toward an electric fireplace including a grate including an upper surface; a log assembly that is supported by the grate, the log assembly including a plurality of simulated logs that are positioned relative to one another to define an assembly opening; and a flame generator that is positioned substantially adjacent to the upper surface of the grate, the flame generator being configured to direct light at the log assembly to generate a three-dimensional simulated flame.

Additionally, the present invention is also directed toward a method of manufacturing an electric fireplace including providing a grate including an upper surface; supporting a log assembly with the grate, the log assembly including a plurality of simulated logs that are positioned relative to one another to define an assembly opening; positioning a flame generator substantially adjacent to the upper surface of the grate; and directing light at the log assembly with the flame generator to generate a three-dimensional simulated flame.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a front perspective view illustration of an embodiment of an electric fireplace having features of the present invention;

FIG. 2 is a partially exploded rear perspective view illustration of the electric fireplace illustrated in FIG. 1;

FIG. 3A is a front perspective view illustration of a portion of another embodiment of the electric fireplace;

FIG. 3B is a partially exploded perspective view illustration of the portion of the electric fireplace illustrated in FIG. 3A;

FIG. 3C is a simplified front view illustration of the portion of the electric fireplace illustrated in FIG. 3A;

FIG. 3D is a rear perspective view illustration of the portion of the electric fireplace illustrated in FIG. 3A;

FIG. 3E is a simplified rear view illustration of the portion of the electric fireplace illustrated in FIG. 3A;

FIG. 3F is a simplified side view illustration of the portion of the electric fireplace illustrated in FIG. 3A;

FIG. 3G is a simplified bottom view illustration of the portion of the electric fireplace illustrated in FIG. 3A;

FIG. 3H is a simplified top view illustration of the portion of the electric fireplace illustrated in FIG. 3A;

FIG. 3I is a cross-sectional side view illustration of the portion of the electric fireplace illustrated in FIG. 3H taken on line 31-31;

FIG. 3J is a cross-sectional side view illustration of the portion of the electric fireplace illustrated in FIG. 3H taken on line 3J-3J;

FIG. 4A is a partially exploded top view illustration of a portion of still another embodiment of the electric fireplace;

FIG. 4B is a simplified top view illustration of a portion of the electric fireplace illustrated in FIG. 4A;

FIG. 4C is a simplified top view illustration of the portion of the electric fireplace illustrated in FIG. 4A;

FIG. 4D is a partially exploded top view illustration of a portion of a modified version of the electric fireplace illustrated in FIG. 4A;

FIG. 4E is a simplified top view illustration of the portion of the modified electric fireplace illustrated in FIG. 4D;

FIG. 4F is a simplified top view illustration of a portion of the electric fireplace illustrated in FIG. 4A;

FIG. 4G is a simplified top view illustration of a portion of the electric fireplace illustrated in FIG. 4A;

FIGS. 5A-5K are a set of illustrations showing one representative embodiment of a method of installation of the electric fireplace;

FIG. 6A is a simplified front view illustration of another embodiment of the electric fireplace; and

FIG. 6B is a cross-sectional side view illustration of the electric fireplace illustrated in FIG. 6A taken on line B-B.

### DESCRIPTION

Embodiments of the present invention are described herein in the context of a flame generator for an electric fireplace. More particularly, the flame generator for the electric fireplace is configured to generate a realistic looking, three-dimensional simulated flame within the electric fireplace. Additionally, the flame generator includes a relatively simple design that is easily implemented into the electric fireplace. In certain non-exclusive embodiments, as described herein, the flame generator can be implemented into an electric fireplace having a modular design that enables greater flexibility to the consumer for the overall design of the electric fireplace, as well as offering various cost and product development efficiencies. For example, numerous options for different components of the electric fireplace can be incorporated together in any desired manner to provide various alternatives for the consumer in terms of the overall size, shape, design and aesthetic appearance of the electric fireplace. Further, in some embodiments, electrical connections for certain components of the electric fireplace can be configured to enable the consumer to easily and safely establish such electrical connections so that power is provided to all such electrical components of the electric fireplace.

Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same or similar nomenclature and/or reference indicators will be used throughout the drawings and the following detailed description to refer to the same or like parts.

In the interest of clarity, not all of the routine features of the implementations described herein are shown and described. It is appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

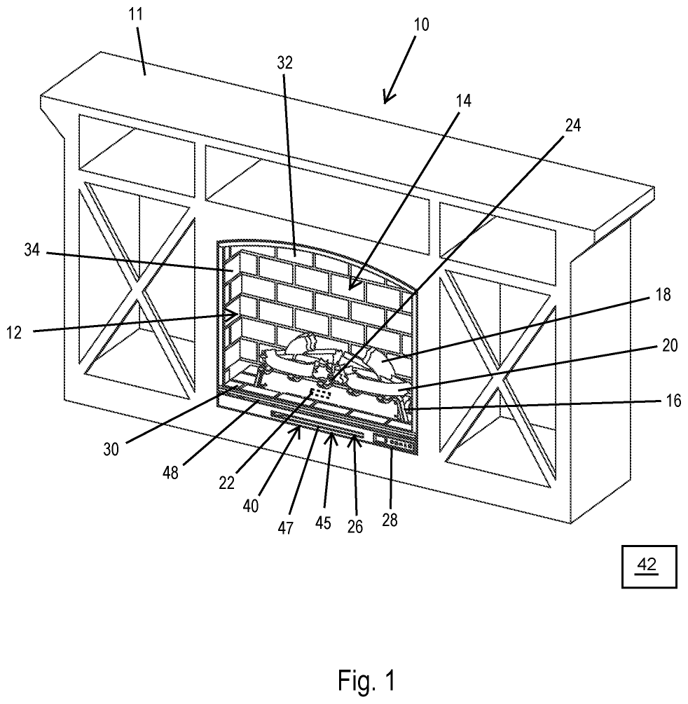

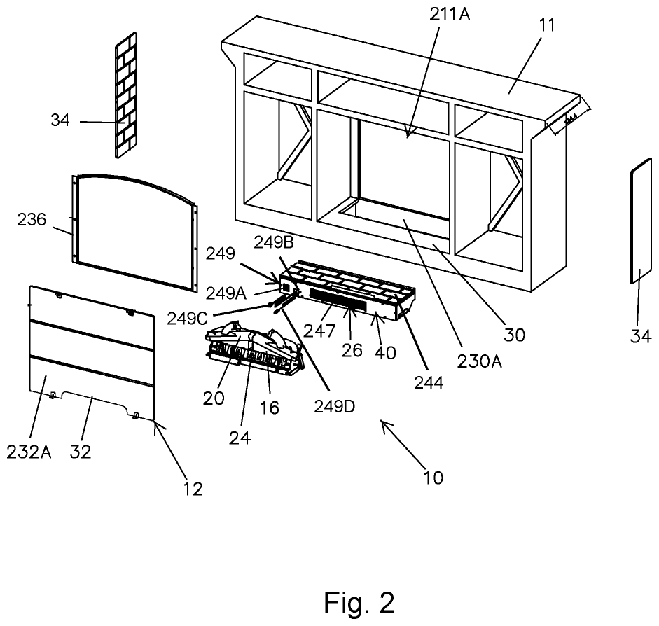

FIG. 1 is a front perspective view illustration of an embodiment of an electric fireplace 10 having features of the present invention. Additionally, as shown, the electric fireplace 10 is positioned and/or integrated into a cabinet 11 having a structural opening 211A (illustrated more clearly in FIG. 2) that is configured to receive the electric fireplace 10. It is appreciated that the cabinet 11 and/or the structural opening 211A can be of any suitable size, shape and design, which can be different than what is specifically shown in FIG. 1. Thus, the specific size, shape and design of the cabinet 11 and/or the structural opening 211A illustrated in the Figures is not intended to be limiting in any manner. Additionally, it is further appreciated that in some alternative embodiments, the cabinet 11 can also be provided in the form of a modular cabinet assembly that is configured to be assembled by the consumer, prior to and/or in conjunction with the assembly and installation of the electric fireplace 10 within the structural opening 211A of the cabinet 11.

As illustrated herein, the electric fireplace 10 can be used to provide heat and to simulate a wood burning fire, e.g., in a room of a home or other type of building. More particularly, in certain embodiments, the electric fireplace 10 can be configured to look like a traditional wood-burning fireplace, although the electric fireplace 10 does not actually burn wood.

The design of the electric fireplace 10 can be varied. In certain embodiments, as illustrated in FIG. 1, the electric fireplace 10 can include (i) a fireplace housing 12 including one or more of a base panel 30, a back panel 32, side panels 34 and a front frame 236 (illustrated more clearly in FIG. 2); (ii) a viewing area 14 that is defined within the fireplace housing 12; (iii) a grate 16; (iv) a simulated flame 18 (i.e. which is visible when the electric fireplace 10 is in use); (v) one or more simulated logs 20; (vi) a light source 22 (illustrated as a box in phantom) and/or a simulated flame generator 24 (also sometimes referred to herein simply as a “flame generator”) that can be used to selectively generate the simulated flame 18 and/or to create a glowing effect for the simulated logs 20; (vii) a heater assembly 26; and (viii) a controller 28. In some such embodiments, the heater assembly 26 and the controller 28 can be packaged together into an integrated electrical insert 40. Additionally, although not specifically shown in FIG. 1, the electric fireplace 10 can further include an electrical connection assembly 249 (illustrated, for example, in FIG. 2) including greatly simplified electrical connections that enable power to be easily provided to various electrical components of the electric fireplace 10. Alternatively, the electric fireplace 10 can include more components or fewer components than those specifically illustrated in FIG. 1. For example, in one non-exclusive alternative embodiment, the electric fireplace 10 can further include a simulated emberbed. Still alternatively, the electric fireplace 10 can be configured without the heater assembly 26. Yet alternatively, the various components of the electric fireplace 10 can be positioned in a different manner than that shown in FIG. 1.

As utilized herein, the fireplace housing 12 is also sometimes referred to generally as a “mantel”, and the additional components of the electric fireplace 10 that are selectively positioned within the fireplace housing 12, e.g., during use and/or packaging of the electric fireplace 10, are also sometimes referred to generally as an “insert”.

As an overview, in various embodiments, the flame generator 24 is uniquely configured to generate a realistic looking, three-dimensional simulated flame 18 within the electric fireplace 10 where light is directed and/or reflected in different directions away from the simulated logs 20. With such design, the electric fireplace 10 has a more pleasing overall aesthetic appearance for the consumer.

Additionally, as noted, in some embodiments, the electric fireplace 10 can be formed with a modular design such that various components are manufactured and installed independently of one another. Stated in another manner, the electric fireplace 10 can be constructed via a knock/down (“K/D”) method, and one or more of the components can be K/D components that can be individually installed by the user or consumer. Moreover, certain components of the electric fireplace 10 can be positioned in different locations within the structural opening 211A of the cabinet 11 to suit the particular desires of the consumer. With such design, the electric fireplace 10 can be constructed by the consumer, i.e. at the consumer level, from the component parts, and need not be constructed at the manufacturer/factory level as is done with typical electric fireplaces. Additionally, with such design, the electric fireplace 10 and the components thereof can be configured to have any suitable size, shape, design and aesthetic appearance depending on the preferences of the consumer. Thus, with the modular design described herein, the consumer is provided with a larger variety of options for the overall design (e.g., size, shape and aesthetic appearance) of the electric fireplace 10, thus enhancing consumer control and happiness, while still enabling various cost and product development efficiencies.

Further, in certain such embodiments, individual components of the fireplace housing 12 can be flexible or foldable, and/or various components can be configured to fit together compactly when installed and in use. Thus, with such design features, the electric fireplace 10 is configured to enable space efficiencies during packaging, shipping and/or storing of the electric fireplace 10.

Still further, due to the inclusion of the easy-to-use electrical connection assembly 249, the consumer is able to easily and safely establish all necessary electrical connections, e.g., between the electrical insert 40 (the heater assembly 26 and/or the controller 28) and the grate 16 (the light source 22 and/or the flame generator 24), and between the electric insert 40 (the heater assembly 26 and/or the controller 28) and/or the grate 16 and an external power source 42 (illustrated as a box) such as an electrical outlet.

Upon installation of the electric fireplace 10, the fireplace housing 12 can be sized and shaped to retain most, if not all, of the remaining components of the electric fireplace 10. In particular, in many embodiments, the grate 16, the simulated flame 18 (i.e. when the electric fireplace 10 is in use), the one or more simulated logs 20, the light source 22, the flame generator 24, the heater assembly 26 and the controller 28 can be positioned substantially within the fireplace housing 12 once the electric fireplace 10 has been installed and prepared for use. In some embodiments, as shown in FIG. 1, the fireplace housing 12 can be installed and configured to have a substantially rectangular shape. Alternatively, the fireplace housing 12 can be installed and configured to have a different shape depending on the preferences of the consumer and the limitations of the structural opening 211A within which the electric fireplace 10 is being installed.

Further, the fireplace housing 12, and the various individual components thereof, can be formed from any suitable materials. For example, in some embodiments, the fireplace housing 12, and the various individual components thereof, can be formed from any of a number of suitable metallic materials. Alternatively, the fireplace housing 12, and the various individual components thereof, can be formed from any other suitable materials.

The viewing area 14 is the area within the fireplace housing 12 in which the grate 16, the simulated flame 18, the simulated logs 20, and the simulated emberbed (when included) are displayed and can be seen by the user.

As illustrated, the grate 16, i.e. an actual or simulated grate, is configured to support the simulated logs 20 above the base panel 30 of the fireplace housing 12. Additionally, as shown in this embodiment, the grate 16 can be positioned substantially directly above the base panel 30 and/or the electrical insert 40 (sometimes referred to collectively as the “base module”).

Further, the grate 16 can also be formed from any suitable materials. For example, in certain non-exclusive alternative embodiments, the grate 16 can be formed from metallic materials such as a welded steel or aluminum material. Alternatively, the grate 16 can be formed from plastic, resin, and/or another suitable material.

As shown in FIG. 1, in various embodiments, the simulated flame 18 is displayed within the viewing area 14 of the electric fireplace 10. The simulated flame 18 is configured to give the electric fireplace 10 a more realistic appearance, i.e. to make the electric fireplace 10 look more like a traditional wood-burning fireplace. The simulated flame 18 can be formed from any suitable method. For example, in some embodiments, the electric fireplace 10 can utilize the light source 22 to illuminate a reflective medium, such as a suitable metal material, to generate the simulated flame 18 in the form of a flickering flame image. Additionally and/or alternatively, the simulated flame 18 can be generated through specific use of the flame generator 24 that is specifically configured to generate the simulated flame 18. Still alternatively, the simulated flame 18 can be generated in another suitable manner. Certain embodiments of the flame generator 24 will be described in greater detail herein below.

As noted above, upon installation, the simulated (or artificial) logs 20 can be retained within the fireplace housing 12 and thus positioned within the viewing area 14. Additionally, in certain embodiments, the simulated logs 20 can utilize the light source 22, the flame generator 24 and/or a separate light source to create a glowing effect for the simulated logs 20. Thus, the combination of the simulated logs 20 and the simulated flame 18 can use the light source 22, the flame generator 24 and/or a separate light source to create the appearance of burning logs, thereby closely simulating the flames of a wood-burning fireplace. As illustrated, the simulated logs 20 can further be placed on top of and/or can be fixedly secured to the grate 16, e.g., with one or more log fasteners. Alternatively, in one embodiment, the simulated logs 20 can be integrally formed with the grate 16.

Additionally, the simulated logs 20 can be formed from any suitable materials. For example, in certain non-exclusive alternative embodiments, the simulated logs 20 can be hollow molded logs that are formed from a molded resin material. Alternatively, the simulated logs 20 can be formed from another suitable material.

In some embodiments, when included as part of the electric fireplace 10, the simulated emberbed can be positioned adjacent to the base panel 30 of the fireplace housing 12 and substantially directly below the grate 16. Additionally, the simulated emberbed can also utilize the light source 22, the flame generator 24 and/or a separate light source to create a glowing effect for the simulated emberbed. It is appreciated that the glowing effect for the simulated emberbed can further enhance the overall look of the electric fireplace 10 to be more like that of a traditional wood-burning fireplace.

Further, the simulated emberbed can be formed from any suitable materials. For example, in certain non-exclusive alternative embodiments, the simulated emberbed can be formed from a molded resin material. Alternatively, the simulated emberbed can be formed from another suitable material.

As noted above, in some embodiments, the light source 22 can be configured to assist in the generation of the simulated flame 18, as well as helping to create the glowing effect for the simulated logs 20 and/or the simulated emberbed. Stated in another manner, in such embodiments, the light source 22 can be utilized, i.e. selectively activated, for purposes of generating the simulated flame 18, creating a glowing effect for the simulated logs 20, and/or creating a glowing effect for the simulated emberbed.

The light source 22 can have any suitable design. For example, in one non-exclusive alternative embodiment, the light source 22 can include a flat, PCB board upon which is mounted an LED panel having one or more LED light bulbs. It is appreciated that the use of LED light bulbs makes it generally unnecessary to access the light source 22 as the LED light bulbs have a very long life span and do not need to be regularly replaced. Alternatively, the light source 22 can have another suitable design, e.g., can include other types of light bulbs or another type of light source. Additionally, the light source 22 can be positioned in any suitable manner for purposes of more effectively generating the simulated flame 18, creating a glowing effect for the simulated logs 20, and/or creating a glowing effect for the simulated emberbed, as desired.

In some embodiments, the light source 22 can be incorporated and/or formed into the structure of the grate 16. Thus, with the light source 22 incorporated into the grate 16, additional size and space efficiencies can be achieved. Additionally, with such design, electrical connection to the light source 22 can be provided via the grate 16, e.g., via electrical connection ports coupled to the light source 22 via the grate 16 and electrical connectors that can be coupled into the electrical connection ports. Alternatively, the light source 22 can be provided independently of the grate 16.

Similarly, as noted above, the flame generator 24 can also or alternatively be configured to assist in the generation of the simulated flame 18, as well as helping to create the glowing effect for the simulated logs 20 and/or the simulated emberbed. Stated in another manner, the flame generator 24 can be utilized, i.e. selectively activated, in conjunction with the light source 22 or in lieu of the light source 22, for purposes of generating the simulated flame 18, creating a glowing effect for the simulated logs 20, and/or creating a glowing effect for the simulated emberbed.

In some embodiments, the flame generator 24 can be incorporated and/or formed into the structure of the grate 16. Thus, with the flame generator 24 incorporated into the grate 16, additional size and space efficiencies can be achieved. Additionally, with such design, electrical connection to the flame generator 24 can be provided via the grate 16, e.g., via electrical connection ports coupled to the flame generator 24 via the grate 16 and electrical connectors that can be coupled into the electrical connection ports. Alternatively, the flame generator 24 can be provided independently of the grate 16.

Further, in certain embodiments, the grate 16 and the light source 22 and/or the flame generator 24, as well as the simulated logs 20, can be independent components that can be installed within the structural opening 211A by the user. Still further, in some embodiments, the grate 16 with the light source 22 and/or the flame generator 24, as well as the simulated logs 20, can be provided together and can be positioned on top of the base module, i.e. the base panel 30 and/or the electrical insert 40, during packaging and/or during use of the electric fireplace 10.

Additionally, in some embodiments, the flame generator 24 and/or the light source 22 can be powered through use of the electrical connection assembly 249. For example, in some embodiments, the electrical connection assembly 249 can include an AC connector, or other suitable electrical connector, that is selectively electrically connected to the external power source 42, and a user-friendly, low voltage DC connector that can be selectively electrically connected to and/or between the heater assembly 26 and the grate 16 to provide the necessary power to the flame generator 24 and/or the light source 22. Thus, in some such embodiments, the necessary power is provided to the light source 22 and/or the flame generator 24 indirectly from the external power source 42 via the heater assembly 26. In certain such embodiments, an electrical cable can be utilized to extend through an opening in an insert cover 244 (illustrated in FIG. 2). Further, in some embodiments, the grate 16, with the light source 22 and/or the flame generator 24 incorporated therein, can be connected to the electrical insert 40 with a user-friendly, low voltage connector, e.g., a USB cable assembly, a 3.5 mm jack or other suitable low voltage DC connector. Further, in certain alternative embodiments, the grate 16, with the light source 22 and/or the flame generator 24 incorporated therein, can also be included as part of the base module, e.g., included with the electrical insert 40 that is mounted within base opening 230A formed into the base panel 30. In certain alternative embodiments, the power to the flame generator 24 and/or the light source 22 can be provided by other than the external power source 42, e.g., from an internal power source or other suitable power source.

As utilized herein, in certain non-exclusive alternative embodiments, a low voltage connector, a low voltage cable and/or a low voltage cable assembly, is one that is configured to carry less than approximately 50 volts, less than approximately 45 volts, less than approximately 40 volts, less than approximately 35 volts, less than approximately 30 volts, less than approximately 25 volts, less than approximately 20 volts, less than approximately 15 volts, less than approximately 10 volts, or less than approximately 5 volts.

It is appreciated that such quick and easy electrical connections possible for the consumer with the electrical connection assembly 249 provide a much more user-friendly experience for the consumer that does not entail hard-wired electrical connections which are typical in previous electric fireplaces. The electrical connection assembly 249, with its unique design, also enables the electrical connections to be easily and safely undertaken by the consumer at the consumer level, rather than being hard-wired at the factory level as occurs in typical electrical fireplaces.

As provided herein, it is appreciated that the light source 22 and the flame generator 24 can be utilized individually or in conjunction with one another for purposes of generating the simulated flame 18 (as well as providing a glowing effect for the simulated logs 20 and/or the simulated emberbed). Accordingly, the light source 22 and the flame generator 24 can sometimes be generally referred to, individually or collectively, as a “flame generator”.

The heater assembly 26, e.g., an integrated electric heater assembly, can be configured to provide heated air which can be directed in a generally outward direction away from the electric fireplace 10. More particularly, in certain embodiments, the heater assembly 26 can include a heater body 45, a heat generator 46 and a fan or blower 247 (illustrated in FIG. 2) that are positioned substantially within the heater body 45, and a grill cover 48 that is positioned substantially directly adjacent to and/or is mechanically coupled or secured to the heater body 45. In such embodiments, the heat generator 46 (also referred to as heating elements in certain embodiments) is configured to generate heat, and the blower 247 is configured to blow the heat from the heat generator 46 in the form of hot air through an air outlet (not shown in FIG. 1) formed into the heater body 45 and subsequently through the grill cover 48, e.g., heat vents, into the area surrounding the electric fireplace 10, such as a room in a house, in order to heat such area.

As with the light source 22 and/or the flame generator 24, power for the heater assembly 26 can be provided directly or indirectly to the heater assembly 26 from the external power source 42 or another suitable power source.

In some embodiments, as shown in FIG. 1, the grill cover 48 can be coupled to and/or incorporated into the electrical insert 40 and positioned near and/or adjacent to the base panel 30 of the fireplace housing 12. In such embodiments, the grill cover 48 is so positioned to allow heat to be directed generally upwardly away from the electrical insert 40. Thus, the heated air can be moved into and through the area surrounding the electric fireplace 10, e.g., a room in a house, in order to heat such area. Additionally, with such design and positioning of the heater assembly 26 and/or the grill cover 48, the heat can be projected to rise up at an angle and away from the heater assembly 26 so that it feels more like it is actually emanating from the fire itself.

Alternatively, the heater assembly 26, i.e. the heater body 45 with the grill cover 48 coupled thereto, can be positioned in a different manner, e.g., at or near an upper portion of the fireplace housing 12, or near and/or adjacent to one or both of the side panels 34 of the fireplace housing 12. For example, in one non-exclusive alternative embodiment, the cabinet 11 can include a center shelf (not shown), and the heater assembly 26 and/or the grill cover 48 can be attached to, mounted on and/or positioned substantially adjacent to the center shelf of the cabinet 11. In such alternative embodiment, at least a majority of the components of the electric fireplace 10 will be positioned within the structural opening 211A of the cabinet 11 below the center shelf, with the heater assembly 26 being attached to, mounted on and/or positioned substantially adjacent to the center shelf of the cabinet 11 and above the other components of the electric fireplace 10.

The controller 28 can include one or more circuits or processors that can be utilized to control the various functions of the electric fireplace 10. For example, the controller 28 can be utilized to activate and/or control (i) the intensity of the light source 22 and/or the flame generator 24 within the electric fireplace 10 that generates the simulated flame 18, (ii) the intensity of the light source 22 and/or the flame generator 24 within the electric fireplace 10 that creates the glowing effect for the simulated logs 20, (iii) the intensity of the light source 22 and/or the flame generator 24 within the electric fireplace 10 that creates the glowing effect for the simulated emberbed, (iv) the intensity of the heat generator 46 within the heater assembly 26 to regulate the amount of heat produced by the heater assembly 26, and (v) the speed of the blower 247 within the heater assembly 26 to regulate the velocity of heat being dispersed by the heater assembly 26.

As with the light source 22, the flame generator 24 and/or the heater assembly 26, power for the controller 28 can be provided directly or indirectly to the controller 28 from the external power source 42 or another suitable power source.

In some embodiments, the various electrical components of the electric fireplace 10, e.g., the light source 22, the flame generator 24, the heater assembly 26 and the controller 28, can be packed separately, such as when the electric fireplace 10 and/or the fireplace housing 12 is provided in a knock-down (“K/D”) mantel configuration. Additionally, in certain embodiments, this portion of the electric fireplace 10 can also be sourced from an electrical factory. However, since these components can be formed as a relatively simple DC module, with no certifications required, these components could also potentially be sourced locally.

Additionally, in this embodiment, with all of the electrical components located embedded within, near and/or adjacent to the base panel 30, such components do not adversely inhibit the desired size and shape of the opening.

It is appreciated that in some implementations, certain electrical components of the electric fireplace 10, e.g., the heater assembly 26 and the controller 28 that combine to form the electrical insert 40, can be fully assembled at the factory level prior to the components being packaged and shipped commercially. Alternatively, some assembly of such electrical components can be done at the consumer level, provided necessary safety requirements can be met.

FIG. 2 is a partially exploded rear perspective view illustration of the electric fireplace 10 illustrated in FIG. 1. Additionally, FIG. 2 further illustrates the cabinet 11 including the structural opening 211A into which the electric fireplace 10 can be installed. In the condition as shown in FIG. 2, only the base panel 30 of the fireplace housing 12 has so far been installed and/or integrated within the structural opening 211A of the cabinet 11.

As illustrated, FIG. 2 shows that the electric fireplace 10 can include the fireplace housing 12 including the base panel 30 (sometimes also referred to as a “mantel base”), the back panel 32, side panels 34, and the front frame 236, the grate 16, the one or more simulated logs 20, and the electrical insert 40. As described above, in this embodiment, at least the heater assembly 26 and the controller 28 (illustrated in FIG. 1) are incorporated together within the electrical insert 40. Further, it is appreciated that, although not shown in FIG. 2, in some embodiments, the electrical insert 40 can further include and/or incorporate the light source 22 (illustrated in FIG. 1) and/or the flame generator 24. Still further, since FIG. 2 is showing an exploded, and thus non-operational, view of the electric fireplace 10, the viewing area 14 (illustrated in FIG. 1), and the simulated flame 18 (illustrated in FIG. 1) are also not illustrated in FIG. 2.

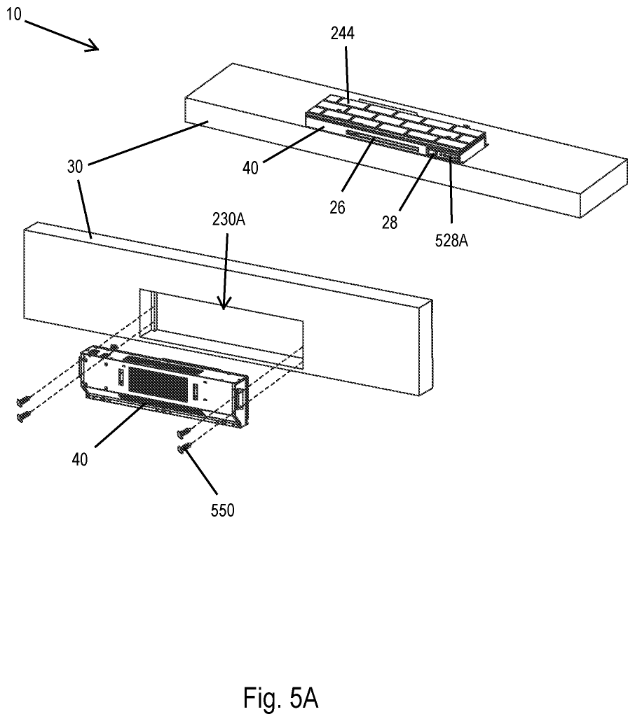

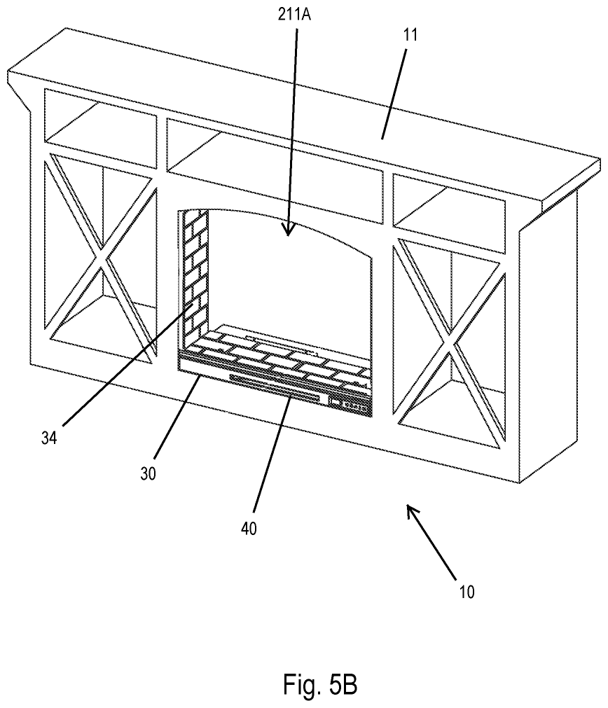

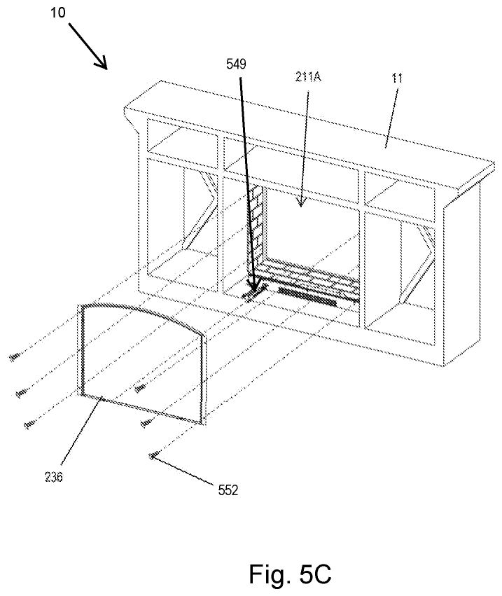

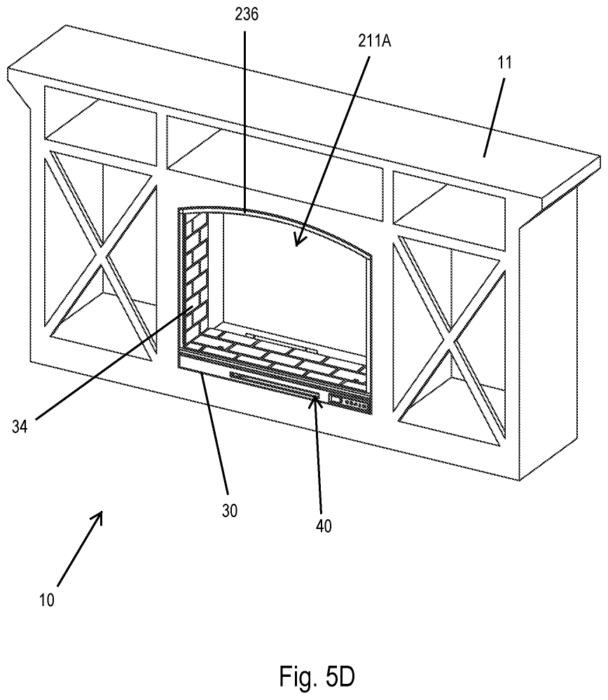

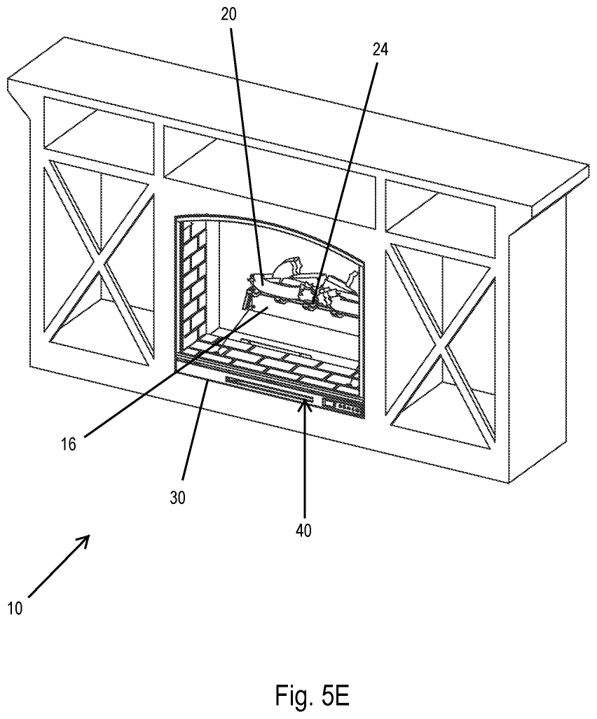

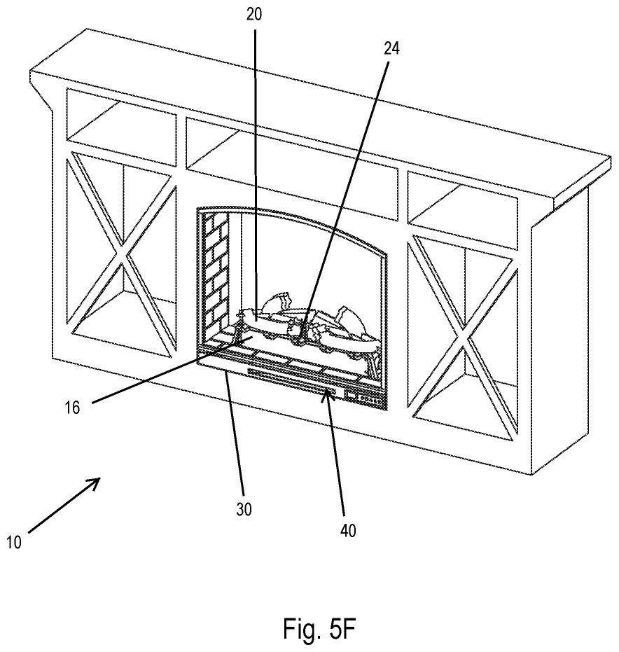

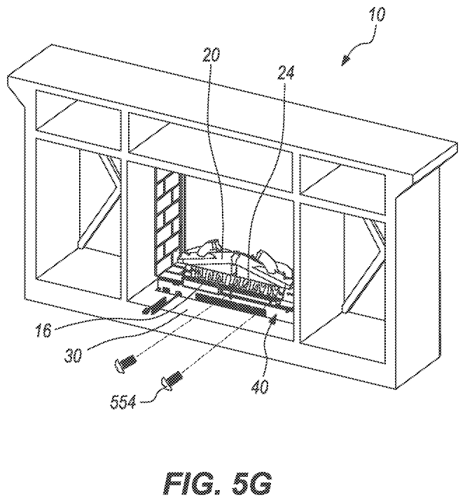

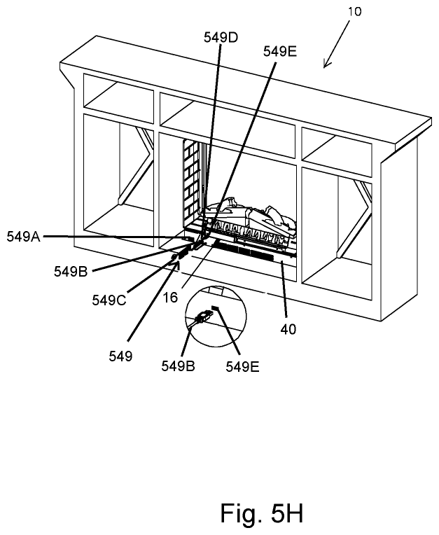

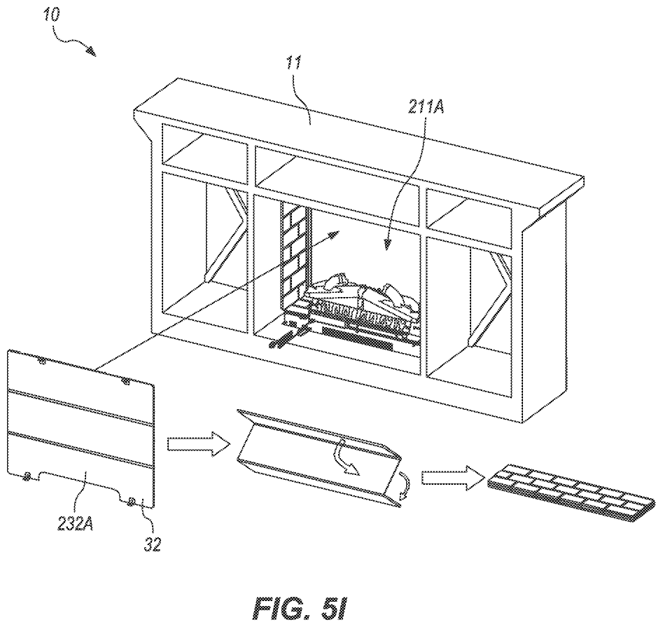

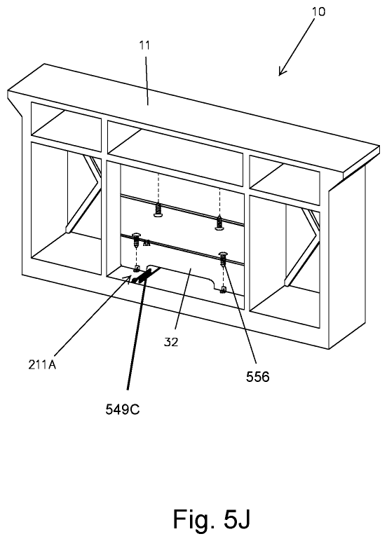

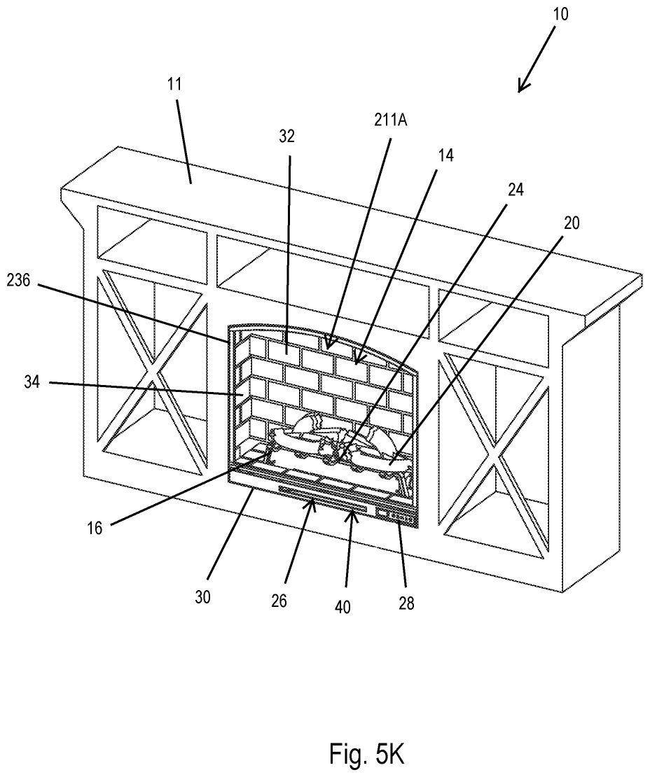

As noted above, the base panel 30, the back panel 32, the side panels 34 and the front frame 236 can have any suitable design. Additionally, the design, size and shape of the base panel 30, the back panel 32, the side panels 34 and the front frame 236 can be mixed and matched as desired to provide greater flexibility to the consumer for the overall design of the electric fireplace 10. Further, in certain embodiments, one or more of the back panel 32 and the side panels 34 can be flexible and/or foldable such that they take up much less space for purposes of packaging, shipping and storage. More particularly, in such embodiments, one or more of the back panel 32 and the side panels 34 can be movable between an unfolded configuration and a folded configuration. Such movement between the unfolded configuration and the folded configuration is demonstrated herein in relation to FIG. 5I.

One objective of the construction of the electric fireplace 10, as described in detail herein, is to embed the various operational components of the electric fireplace 10 into the components of the fireplace housing 12 to make the combined packaging substantially the same size as a typical packaging of only the fireplace housing 12. For example, as illustrated in FIG. 2, the base panel 30 (or mantel base) can include the base opening 230A (or base aperture) that is configured to receive the electrical insert 40. More particularly, as shown, a lower portion of the electrical insert 40 is sized and shaped to fit and be supported and retained within the base opening 230A that is formed into the base panel 30. Further, as illustrated, the electric fireplace 10 can also include an insert cover 244 that is configured to fit over the electrical insert 40, such that the base panel 30 and the insert cover 244 provide an outer housing for the electrical insert 40 that is positioned compactly therein.

With such design, the bulky components of the heat generator 46 and the motor blower 247 of the heater assembly 26, as retained within the heater body 45, and the controller 28, which are integrated and/or incorporated together within the electrical insert 40, are now positioned to be embedded within the base opening 230A of the base panel 30. This allows for the viewing area 14 (illustrated in FIG. 1) to not be impeded with these bulky components as only the heat outlet, i.e. the grill cover 48 (illustrated in FIG. 1) and/or the insert cover 244, will slightly protrude over the lip of the base panel 30. Further, this also allows for the electrical insert 40 to be pre-assembled into the base panel 30, i.e. into the base opening 230A, at the factory level without impeding packaging efficiency and reducing the level of assembly required at the consumer level.

The back panel 32 and the side panels 34 can have any suitable design to create any suitable aesthetic appearance. In some embodiments, as shown in FIG. 2, the back panel 32 and/or the side panels 34 can have a brick-like appearance. Alternatively, the back panel 32 and/or the side panels 34 can have another suitable design, e.g., a magnesium oxide or stone façade, or another suitable design. Further, or in the alternative, in certain embodiments, the back panel 32 and/or the side panels 34 can be reversible to provide different options of backdrop style at the user level.

Additionally, in certain such embodiments, the back panel 32 and/or the side panels 34 can be foldable and can be mounted on a segmented substrate. In one such embodiment, as shown in FIG. 2, only the back panel 32 is mounted on a segmented substrate 232A so as to be foldable, i.e. movable between the unfolded configuration and the folded configuration. It is appreciated that such design as shown in FIG. 2 for the back panel 32 can also be used for the side panels 34. It is further appreciated that the maintaining of the portions or segments of the segmented substrates 232A together and selectively foldable within the back panel 32 and/or the side panels 34 can be accomplished in any suitable manner. For example, in one non-exclusive embodiment, the segments are held together with a PVC lamination which can fold at the segments, but which looks like a single part when unfolded. In such embodiment, only the substrate 232A is segmented and not the PVC lamination. Alternatively, the segments of the segmented substrate 232A can be maintained together in another suitable manner. Still alternatively, the back panel 32 and/or the side panels 34 can have a different design than what is shown in FIG. 2.

With such design, despite being foldable, the back panel 32 and/or the side panels 34 can still possess the desired strength, rigidity and sturdiness to help form the fireplace housing 12 for the electric fireplace 10. Additionally, with the back panel 32 and/or the side panels 34 being foldable, it is appreciated that the back panel 32 and/or the side panels 34 can be more compact during shipping and storage.

It is further appreciated that the back panel 32 and the side panels 34 can be built locally at a mantel factory, since there is no need for special construction at a specialized certified manufacturer. Additionally, the back panel 32 and/or the side panels 34 can be K/D parts that are installed independently as part of the fireplace housing 12 (or mantel) which enables increased depth of the fireplace housing 12 to get a larger and/or better flame projection. The noted design also allows the use of back panels 32 with thicker or heavier textures, and/or allows for multiple back panels 32 to be included within a single package. It is appreciated that the back panel 32 and the side panels 34 can be attached to the cabinet 11 within the structural opening 211A in any suitable manner. For example, the back panel 32 and the side panels 34 can be attached to the cabinet 11 within the structural opening 211A with an adhesive, with one or more screws or other connectors, or in another suitable manner. Further, in some embodiments, one or more brackets or other stabilizers can also be used to facilitate the attachment of the back panel 32 and/or the side panels 34 within the structural opening 211A of the cabinet 11.

The front frame 236 can also have any suitable size, shape and design. Further, different sizes, shapes and designs for the front frame 236 can be mixed and matched with any designs for the remainder of the electric fireplace 10 and the fireplace housing 12 as desired. For example, in one non-exclusive embodiment, the front frame 236 can be provided in the form of a single pane of glass or glass doors that are closeable so as to more fully enclose the electric fireplace 10. Additionally, or in the alternative, the front frame 236 can be provided with any suitable aesthetic decorative design aspects so as to provide a more ornate appearance. Still alternatively, the front frame 236 can have another suitable design, e.g., a simple mesh screen or any other suitable design. As such, by simply changing the design of the front frame 236, the overall aesthetic appearance of the electric fireplace 10 can be changed without actually changing a majority of the components that are individually included within the electric fireplace 10.

It is appreciated that with the design noted herein, the front frame 236 can be sourced locally and/or built by the mantel factory. In some embodiments, the front frame 236 can be independently formed and provided, and can be installed by the user. With such design, there are no height or shape restrictions for the structural opening 211A within which the electric fireplace 10 is installed, so there could be several options for oversized openings, curved openings, etc.

As noted above, the electrical insert 40 can include at least the heater assembly 26 and the controller 28 integrally provided therein. Further, as shown, the insert cover 244 can be positioned substantially directly on top of the electrical insert 40. In some embodiments, the insert cover 244 can be utilized to enhance the overall aesthetic appearance of the electric fireplace 10. For example, in one such embodiment, the insert cover 244 can have a brick-like appearance that can be configured to match the design of the back panel 32 and the side panels 34. Alternatively, the insert cover 244 can have another suitable design provided for aesthetic purposes, or the insert cover 244 can be configured with no particular design provided thereon.

Additionally, as shown, the electrical connection assembly 249 can be utilized for providing the necessary power to the electrical insert 40, i.e. the heater assembly 26 and/or the controller 28, and also to one or more of the light source 22 and the flame generator 24. As illustrated in FIG. 2, in some embodiments, the electrical connection assembly 249 can include a first electrical connection port 249A that is formed into the electrical insert 40 (and can thus be said to be electrically coupled to the heater assembly 26 and/or the controller 28), a second electrical connection port 249B that is formed into the electrical insert 40 (and can thus be said to be electrically coupled to the heater assembly 26 and/or the controller 28), a first electrical cable assembly 249C (including a first electrical cable and at least one corresponding electrical connector coupled at an end of the first electrical cable), and a second electrical cable assembly 249D (including a second electrical cable and at least one corresponding connector coupled at an end of the second electrical cable). Additionally, the electrical connection assembly 249 can further include a third electrical connection port 549E (illustrated in FIG. 5H) that is formed into the grate 16, which can include the light source 22 and/or the flame generator 24 incorporated therein. Thus, the third electrical connection port 549E can be said to be electrically coupled to the light source 22 and/or the flame generator 24. Alternatively, the electrical connection assembly 249 can include more components or fewer components than what is illustrated and described herein. For example, in one non-exclusive alternative embodiment, the electrical connection assembly 249 can include connection ports and/or electrical cable assemblies, e.g., cables and corresponding connectors, to provide direct connections between the electrical insert 40 (or the heater assembly 26 or the controller 28) and the light source 22, and between the electrical insert 40 (or the heater assembly 26 or the controller 28) and the flame generator 24. As utilized herein, an “electrical cable assembly” includes an electrical cable and at least one electrical connector that is coupled to an end of the electrical cable, or possibly two electrical connectors that are coupled at either end of the electrical cable. Each electrical connector can be an electromechanical device that selectively connects the electrical cable to the respective component. For example, each electrical connector can be a male component that selectively plugs into a corresponding female component. A non-exclusive example of a suitable electrical connector is a USB connector.

In certain embodiments, the first electrical cable assembly 249C, e.g., an AC power cord with corresponding connector(s), or other suitable cable assembly, can include an electrical connector that is plugged into and/or electrically coupled at one end to the first electrical connection port 249A, and another electrical connector that can be electrically connected and/or coupled at the other end to an external power source 42 (illustrated in FIG. 1) such as an electrical outlet, to generally provide power to the electrical insert 40, the heater assembly 26 and/or the controller 28, and thus to the electric fireplace 10 as a whole. Alternatively, in other embodiments, the first electrical cable assembly 249C can be hard-wired into the electrical insert 40 and/or the heater assembly 26, such that the electrical connection assembly 249 can be configured without a specific need for the first electrical connection port 249A to selectively, electrically couple the first electrical cable assembly 249C to the electrical insert 40 and/or the heater assembly 26.

Additionally, in some embodiments, the second electrical cable assembly 249D, e.g., a USB cable with corresponding connector(s) or other similar, low voltage DC electrical cable assembly, can include an electrical connector that is plugged into and/or electrically coupled at one end to the second electrical connection port 249B, and another electrical connector that can be electrically connected and/or coupled at the other end into the third electrical connection port 549E that is formed into the grate 16, in order to transmit power from the electrical insert 40 to the light source 22 and/or the flame generator 24 which can be incorporated into the grate 16. Alternatively, in other embodiments, the second electrical cable assembly 249D can be hard-wired into the electrical insert 40 and/or the heater assembly 26, such that the electrical connection assembly 249 can be configured without a specific need for the second electrical connection port 249B to selectively, electrically couple the second electrical cable assembly 249D to the electrical insert 40 and/or the heater assembly 26; or the second electrical cable assembly 249D can be hard-wired into the grate 16, the light source 22 and/or the flame generator 24, such that the electrical connection assembly 249 can be configured without a specific need for the third electrical connection port 549E to selectively, electrically couple the second electrical cable assembly 249D to the grate 16, the light source 22 and/or the flame generator 24. With such design, in any such embodiments, the electrical connection assembly 249 is able to provide the necessary power to each of the electrical insert 40, i.e. the heater assembly 26 and the controller 28, the light source 22 and the flame generator 24. Additionally, it is further appreciated that such a simple design enables the consumer to quickly and easily establish such electrical connections so that the electric fireplace 10 can be fully assembled and installed by the consumer to desired design specifications.

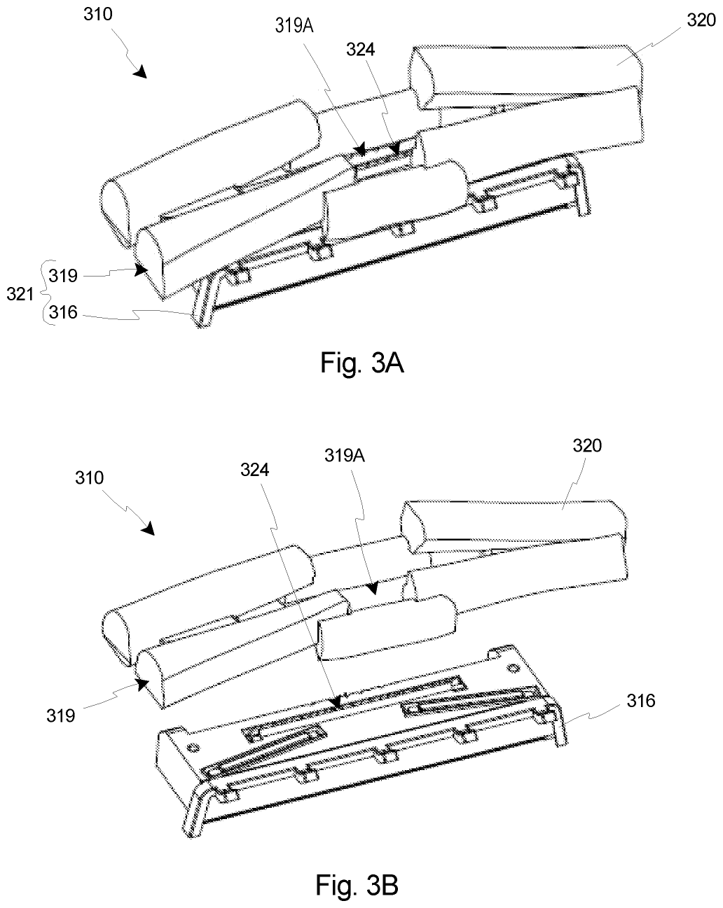

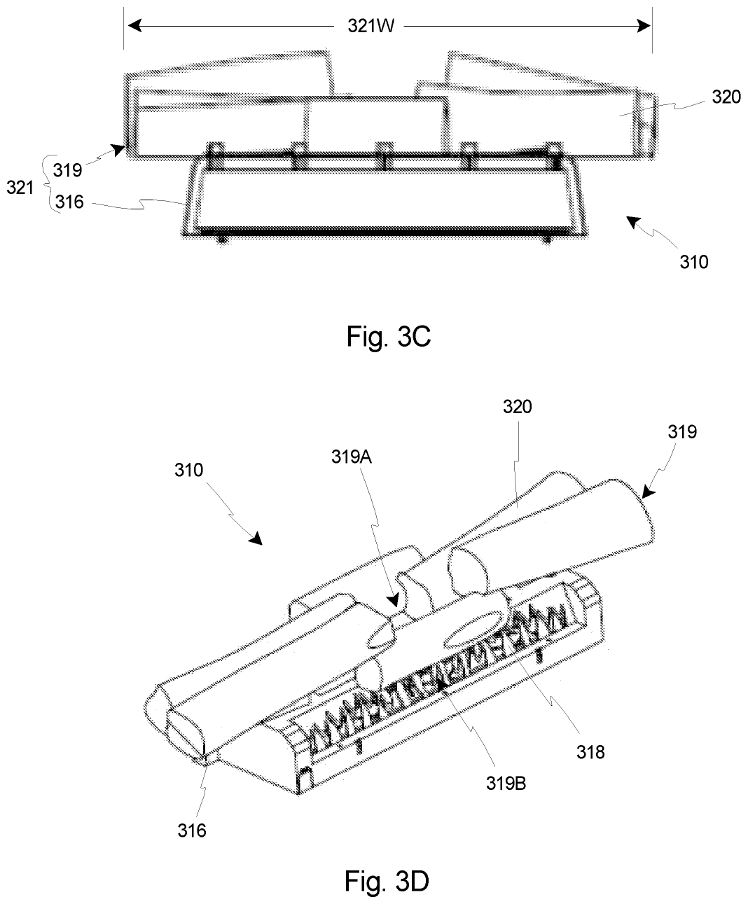

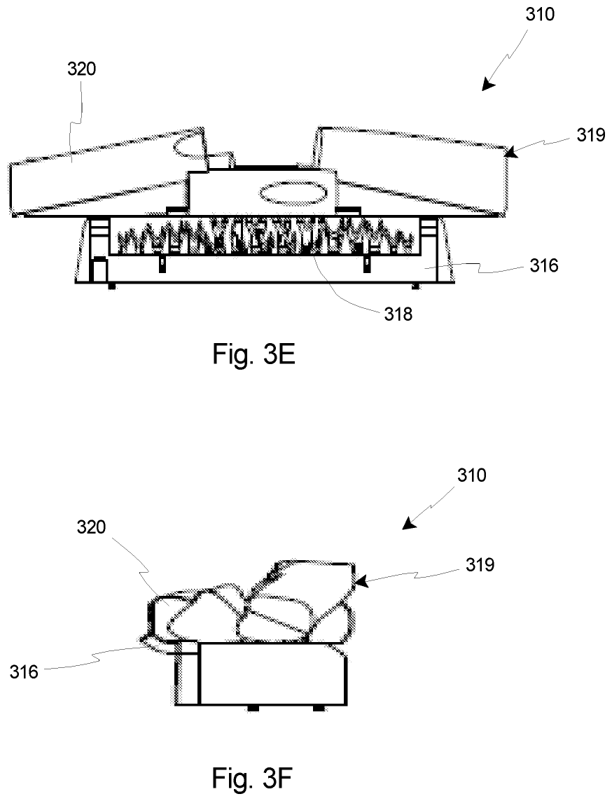

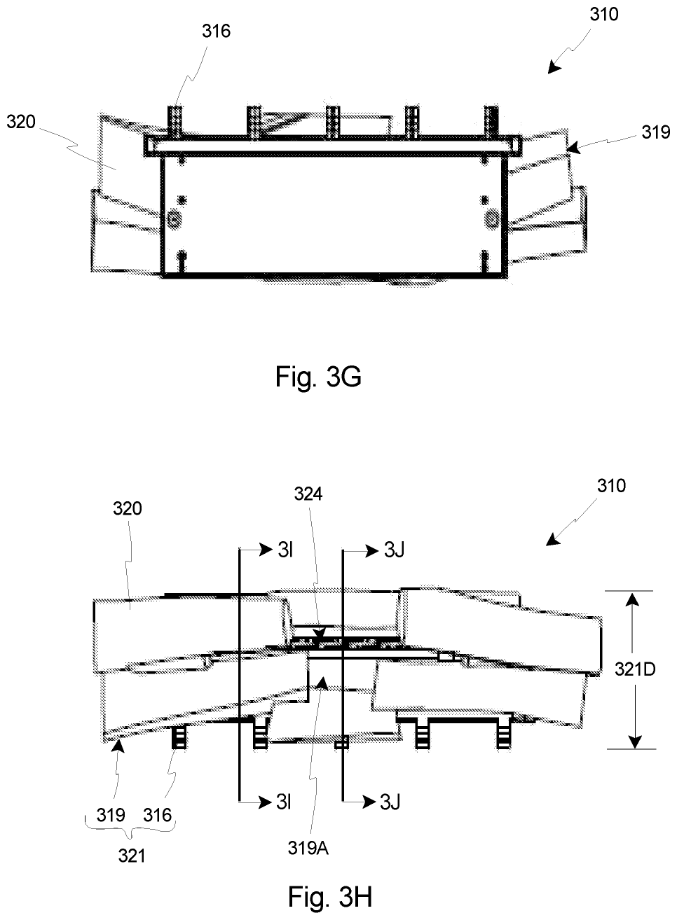

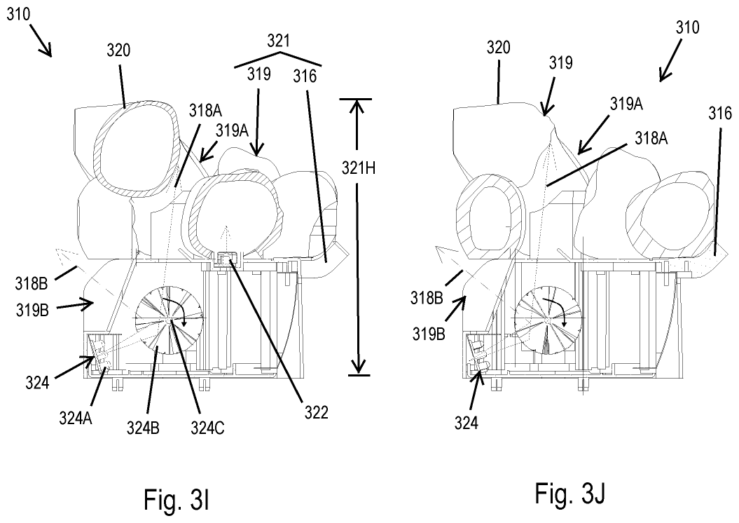

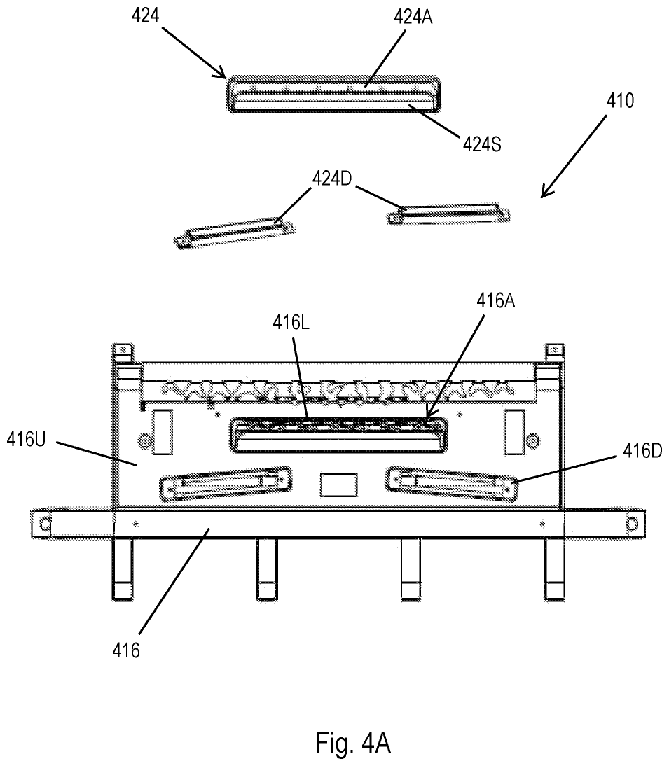

FIG. 3A is a front perspective view illustration of a portion of another embodiment of the electric fireplace 310. In particular, FIG. 3A illustrates a grate 316, a simulated log assembly 319 including a plurality of simulated logs 320 that are mounted on top of and/or fixedly secured to the grate 316, and a portion of a flame generator 324 that is configured to generate the simulated flame 318 (illustrated, for example, in FIG. 3D) that form a portion of the electric fireplace 310. It is appreciated that the electric fireplace 310 can include various other components such as shown and described in relation to the embodiment illustrated in FIG. 1.

The grate 316 is configured to support the log assembly 19 and/or the plurality of simulated logs 320 above the base panel 30 (illustrated in FIG. 1) of the fireplace housing 12 (illustrated in FIG. 1). As above, the grate 316 can have any suitable design and/or can be formed from any suitable materials.

Additionally, in some embodiments, the log assembly 319 and/or the plurality of simulated logs 320 are fixedly secured to the grate 316, e.g., with one or more log attachers (not shown in FIG. 3A). Alternatively, in one embodiment, the log assembly 319 and/or the plurality of simulated logs 320 can be integrally formed with the grate 316. As such, the combination of the log assembly 319 and the grate 316 is sometimes referred to herein as a working assembly 321. The log assembly 319 and/or the plurality of logs 320 can have any suitable design and/or can be formed from any suitable materials.

As shown, in some embodiments, the log assembly 319 includes a first (upper) assembly opening 319A toward an upper, central portion of the log assembly 319. More specifically, in such embodiments, the plurality of simulated logs 320 are positioned relative to one another to define the first (upper) assembly opening 319A between at least two of the plurality of simulated logs 320. Stated in another manner, the plurality of simulated logs 320 contour a hole in the center of the grate 316 which then allows light to escape and reflect light onto the back section of the log assembly 319.

As noted, the flame generator 324 is configured to generate the simulated flame 318 within the fireplace housing 12 of the electric fireplace 310. Additionally, in some embodiments, the flame generator 324 can be incorporated and/or formed into the structure of the grate 316.

In certain embodiments, the flame generator 324 is configured to direct at least a portion of the simulated flame 318 at the log assembly 319 (and exiting from the log assembly 319) in a first flame direction 318A (illustrated in FIG. 3I, and also sometimes referred to herein simply as a “first direction”) through the first (upper) assembly opening 319A formed into the log assembly 319. Additionally, in some embodiments, the flame generator 324 is further configured to direct another portion of the simulated flame 318 at the log assembly 319 (and exiting from the log assembly 319) in a second flame direction 318B (illustrated in FIG. 3I, and also sometimes referred to herein simply as a “second direction”) through a second assembly opening 319B (illustrated, for example, in FIG. 3D), e.g., a rear assembly opening between the log assembly 319 and the flame generator 324 such as shown, for example, in FIG. 3I. As described herein, it is appreciated that the first direction 318A is different than the second direction 318B. With such design, in certain implementations, by having the flame generator 324 direct a portion of the simulated flame 318 through both of the assembly openings 319A, 319B, i.e. in the first direction 318A through the first assembly opening 319A and in the second direction 318B through the second assembly opening 319B, the flame generator 324 is able to generate a simulated flame 318 that has a three-dimensional appearance that is more realistic looking and aesthetically pleasing for the consumer.

As utilized herein, portions of the simulated flame 318 being projected and/or directed at (and exiting away from) the log assembly 319 in the first direction 318A and the second direction 318B is intended to signify general ranges of directions where light, as part of the simulated flame 318, is directed in a range of angles through each of the first assembly opening 319A and the second assembly opening 319B. More specifically, it is appreciated that the general directions and/or ranges of angles for the first direction 318A and the second direction 318B are defined, at least in part, by the specific size and shape of the first assembly opening 319A and the second assembly opening 319B, respectively. For example, in certain non-exclusive embodiments, the first assembly opening 319A can be sized and shaped, and the flame generator 324 can be positioned relative to the first assembly opening 319A, such that a first portion of the simulated flame 318 can be projected through the first assembly opening 319A at a first angular range of between approximately 15 degrees and 45 degrees. In one specific non-exclusive embodiment, the first assembly opening 319A can be sized and shaped, and the flame generator 324 can be positioned relative to the first assembly opening 319A, such that the first portion of the simulated flame 318 can be projected through the first assembly opening 319A at a first angular range of approximately 33 degrees. In other embodiments, the first assembly opening 319A can be sized and shaped, and the flame generator 324 can be positioned relative to the first assembly opening 319A, such that the first portion of the simulated flame 318 can be projected through the first assembly opening 319A at a first angular range of approximately 15 degrees, 20 degrees, 25 degrees, 30 degrees, 35 degrees, 40 degrees or 45 degrees. Alternatively, in still other embodiments, the first assembly opening 319A can be sized and shaped, and the flame generator 324 can be positioned relative to the first assembly opening 319A, such that the first portion of the simulated flame 318 can be projected through the first assembly opening 319A at a first angular range of greater than approximately 45 degrees or less than approximately 15 degrees.

Additionally, in some non-exclusive embodiments, the second assembly opening 319B can be sized and shaped such that a second portion of the simulated flame 318 can be projected through the second assembly opening 319B at a second angular range of between approximately 25 degrees and 80 degrees. In one specific non-exclusive embodiment, the second assembly opening 319B can be sized and shaped, and the flame generator 324 can be positioned relative to the second assembly opening 319B, such that the second portion of the simulated flame 318 can be projected through the second assembly opening 319B at a second angular range of approximately 60 degrees. In other embodiments, the second assembly opening 319B can be sized and shaped, and the flame generator 324 can be positioned relative to the second assembly opening 319B, such that the second portion of the simulated flame 318 can be projected through the second assembly opening 319B at a second angular range of approximately 25 degrees, 30 degrees, 35 degrees, 40 degrees, 45 degrees, 50 degrees, 55 degrees, 65 degrees, 70 degrees, 75 degrees or 80 degrees. Alternatively, in still other embodiments, the second assembly opening 319B can be sized and shaped, and the flame generator 324 can be positioned relative to the second assembly opening 319B, such that the second portion of the simulated flame 318 can be projected through the second assembly opening 319B at a second angular range of greater than approximately 80 degrees or less than approximately 25 degrees.

FIG. 3B is a partially exploded perspective view illustration of the portion of the electric fireplace 310 illustrated in FIG. 3A. In particular, FIG. 3B again illustrates the grate 316, the log assembly 319 including the plurality of simulated logs 320, and the flame generator 324 that form a portion of the electric fireplace 310. Additionally, FIG. 3B also again illustrates the first assembly opening 319A that is formed into and/or defined by the plurality of simulated logs 320 of the log assembly 319.

FIG. 3C is a simplified front view illustration of the portion of the electric fireplace 310 illustrated in FIG. 3A. In particular, FIG. 3C again illustrates the grate 316 and the log assembly 319 including the plurality of simulated logs 320 that combine to form the working assembly 321 that form a portion of the electric fireplace 310.

Additionally, FIG. 3C also illustrates an assembly width 321W of the working assembly 321. In certain non-exclusive alternative embodiments, the assembly width 321W of the working assembly 321 can be between approximately 500 and 1000 millimeters. For example, in one embodiment, the assembly width 321W of the working assembly 321 can be approximately 750 millimeters. In other embodiments, the assembly width 321W of the working assembly 321 can be approximately 500 millimeters, 550 millimeters, 600 millimeters, 650 millimeters, 700 millimeters, 800 millimeters, 850 millimeters, 900 millimeters, 950 millimeters or 1000 millimeters. Alternatively, in still other embodiments, the assembly width 321W of the working assembly 321 can be greater than approximately 1000 millimeters or less than approximately 500 millimeters.

FIG. 3D is a rear perspective view illustration of the portion of the electric fireplace 310 illustrated in FIG. 3A. In particular, FIG. 3D illustrates that the electric fireplace 310 includes the grate 316 and the log assembly 319 that includes the plurality of simulated logs 320. FIG. 3D further illustrates the first assembly opening 319A and the second assembly opening 319B that are formed at least in part by the log assembly 319. In certain implementations, the second assembly opening 319B is irregular shaped (.e.g., jagged shaped) so that the light simulates flame. With this design, light from the flame generator 324 (illustrated in FIG. 3A) is projected onto the second assembly opening 319B to generate a simulated flame 318.

FIG. 3E is a simplified rear view illustration of the portion of the electric fireplace 310 illustrated in FIG. 3A. In particular, FIG. 3E illustrates a simplified rear view of the grate 316 and the log assembly 319 including the plurality of simulated logs 320 that form a portion of the electric fireplace 310. Additionally, FIG. 3E also illustrates the simulated flame 318 that is generated by the flame generator 324 (illustrated in FIG. 3A).

FIG. 3F is a simplified side view illustration of the portion of the electric fireplace 310 illustrated in FIG. 3A. In particular, FIG. 3F illustrates a simplified side view of the grate 316 and the log assembly 319 including the plurality of simulated logs 320 that form a portion of the electric fireplace 310.

FIG. 3G is a simplified bottom view illustration of the portion of the electric fireplace 310 illustrated in FIG. 3A. In particular, FIG. 3G illustrates a simplified bottom view of the grate 316 and the log assembly 319 including the plurality of logs 320 that form a portion of the electric fireplace 310.

FIG. 3H is a simplified top view illustration of the portion of the electric fireplace 310 illustrated in FIG. 3A. In particular, FIG. 3H is a simplified top view illustration showing the grate 316, the log assembly 319 that includes the plurality of simulated logs 320, and the flame generator 324 that form a portion of the electric fireplace 320. FIG. 3H further illustrates the first assembly opening 319A that is formed and/or defined by the plurality of simulated logs 320 of the log assembly 319.

Additionally, FIG. 3H also illustrates an assembly depth 321D of the working assembly 321, i.e. the combination of the grate 316 and the log assembly 319. In certain non-exclusive alternative embodiments, the assembly depth 321D of the working assembly 321 can be between approximately 150 and 450 millimeters. For example, in one embodiment, the assembly depth 321D of the working assembly 321 can be approximately 200 millimeters. In other embodiments, the assembly depth 321D of the working assembly 321 can be approximately 150 millimeters, 175 millimeters, 225 millimeters, 250 millimeters, 275 millimeters, 300 millimeters, 325 millimeters, 350 millimeters, 375 millimeters, 400 millimeters, 425 millimeters or 450 millimeters. Alternatively, in still other embodiments, the assembly depth 321D of the working assembly 321 can be greater than approximately 450 millimeters or less than approximately 150 millimeters.

FIG. 3I is a cross-sectional side view illustration of the portion of the electric fireplace 310 illustrated in FIG. 3H taken on line 31-31. FIG. 3I again illustrates the working assembly 321, i.e. the grate 316 and the log assembly 319 including the plurality of simulated logs 320, and the flame generator 324 that form a portion of the electric fireplace 310.

As described in detail herein, the flame generator 324 is configured to direct light at (and subsequently exiting from) the log assembly 319 in the first direction 318A through the first assembly opening 319A and in the second direction 318B through the second assembly opening 319B. With such design, the flame generator 324 is able to generate a realistic looking, three-dimensional flame within the fireplace housing 12 (illustrated in FIG. 1) of the electric fireplace 310.

The design of the flame generator 324 can be varied. As illustrated in this embodiment, the flame generator 324 includes a single generator light source 324A that generates flame light, a reflective element 324B, and an element mover 324C. Alternatively, the flame generator 324 can have a different design and/or have more components or fewer components than what is illustrated in FIG. 3I. For example, in some non-exclusive alternative embodiments, the flame generator 324 can have multiple generator light sources 324A, with one generator light source 324A directing light at (and subsequently exiting away from) the log assembly 319 in the first direction 318A through the first assembly opening 319A, and another generator light source 324A directing light at (and subsequently away from) the log assembly 319 in the second direction 318B through the second assembly opening 319B.

As noted, the generator light source 324A is configured to generate the flame light. Additionally, the generator light source 324A is designed and/or positioned to direct the flame light toward the reflective element 324B. The generator light source 324A can have any suitable design. For example, in one non-exclusive embodiment, the generator light source 324A includes a strip (or array) of a plurality of LED lights that are coupled to one another, and that are positioned and/or oriented such that light from the LED lights is directed toward the reflective element 324B. More specifically, in such embodiment, the generator light source 324A can include a flat, PCB board upon which is mounted an LED panel having one or more LED light bulbs. It is appreciated that the use of LED light bulbs makes it generally unnecessary to access the generator light source 324A as the LED light bulbs have a very long life span and do not need to be regularly replaced. Alternatively, the generator light source 324A can have another suitable design, e.g., can include other types of light bulbs or another type of light source.

Additionally, the generator light source 324A can be positioned in any suitable manner relative to the reflective element 324B to generate the desired three-dimensional flame effect. For example, in one embodiment, the generator light source 324A can be positioned substantially adjacent to a base of the grate 316 and near the second assembly opening 319B. Further, or in the alternative, in another embodiment, the generator light source 324A can be positioned substantially between two or more of the simulated logs 320 of the log assembly 319. With such design, the generator light source 324A can be utilized to illuminate the space between the simulated logs 320. Moreover, in one embodiment, the generator light source 324A can be controlled to undulate and/or pulse, such as being sequenced to follow one or more other features or components of the electric fireplace 310. In one embodiment, the controller 28 (illustrated in FIG. 1) can be configured (programmed) to control at least a timing, a pulsing and/or a magnitude of the light being generated by the generator light source 324A to more effectively generate a flickering effect for the three-dimensional flame. Stated in another fashion, the controller 28 can direct power to the light source 324A in a pulsed fashion with variable pulse widths and magnitudes to simulate the flame.

In certain, non-exclusive implementations, the reflective element 324B is configured to move, e.g., rotate, so that the flame light from the generator light source 324A is alternatively directed generally towards the log assembly 319 in multiple directions, including in the first direction 318A through the first assembly opening 319A and in the second direction 318B through the second assembly opening 319B. In this embodiment, the reflective element 324B is moved and/or rotated by the element mover 324C so that the flame light from the generator light source 324A is directed by the reflective element 324B away from the log assembly 319 in the first direction 318A through the first assembly opening 319A and in the second direction 318B through the second assembly opening 319B. Stated in another fashion, the rotating reflective element 324B directs the light generally at the log assembly 319 at variable angles.

In another embodiment, the reflective element 324B can be moved and/or rotated by the element mover 324C so that the flame light from the generator light source 324A is directed by the reflective element 324B generally at the log assembly 319 only in the second direction 318B through the second assembly opening 319B, and another generator light source can be utilized to direct flame generally at the log assembly 319 in the first direction 318A through the first assembly opening 319A.

The design of the reflective element 324B can be varied to suit the requirements of the electric fireplace 310. In one non-exclusive embodiment, the reflective element 324B can include a substantially cylindrical tube-shaped base and can further include a plurality of reflective surfaces that are mounted on and/or extend away from the cylindrical tube-shaped base in any suitable manner so that as the reflective element 324B is rotated and alternatively reflects portions of the flame light in the first direction 318A and the second direction 318B, the actual direction of the flame light is varied somewhat from moment-to-moment so that the simulated flame 318 (illustrated in FIG. 3D) better provides the appearance of a flickering flame. Alternatively, the reflective element 324B can have another suitable design.

Additionally, FIG. 3I further illustrates that the electric fireplace 310 can also include a light source 322 that can be used, for example, to create a glowing effect for the plurality of simulated logs 320. For example, in this non-exclusive embodiment, light from the light source 322 can be directed in a generally upward direction into the simulated logs 320 to provide the glowing effect for the simulated logs 320.

Further, FIG. 3I also illustrates an assembly height 321H of the working assembly 321. In certain non-exclusive alternative embodiments, the assembly height 321H of the working assembly 321 can be between approximately 150 and 500 millimeters. For example, in one embodiment, the assembly height 321H of the working assembly 321 can be approximately 210 millimeters. In other embodiments, the assembly height 321H of the working assembly 321 can be approximately 150 millimeters, 200 millimeters, 250 millimeters, 300 millimeters, 350 millimeters, 400 millimeters, 450 millimeters or 500 millimeters. Alternatively, in still other embodiments, the assembly height 321H of the working assembly 321 can be greater than approximately 500 millimeters or less than approximately 150 millimeters.

FIG. 3J is a cross-sectional side view illustration of the portion of the electric fireplace 310 illustrated in FIG. 3H taken on line 3J-3J. FIG. 3J again illustrates the grate 316, the log assembly 319 including the plurality of simulated logs 320, and the flame generator 324 that form a portion of the electric fireplace 310. Additionally, FIG. 3J again illustrates that, in this embodiment, the flame generator 324 is configured to direct light away from the log assembly 319 in the first direction 318A through the first assembly opening 319A and in the second direction 318B through the second assembly opening 319B.

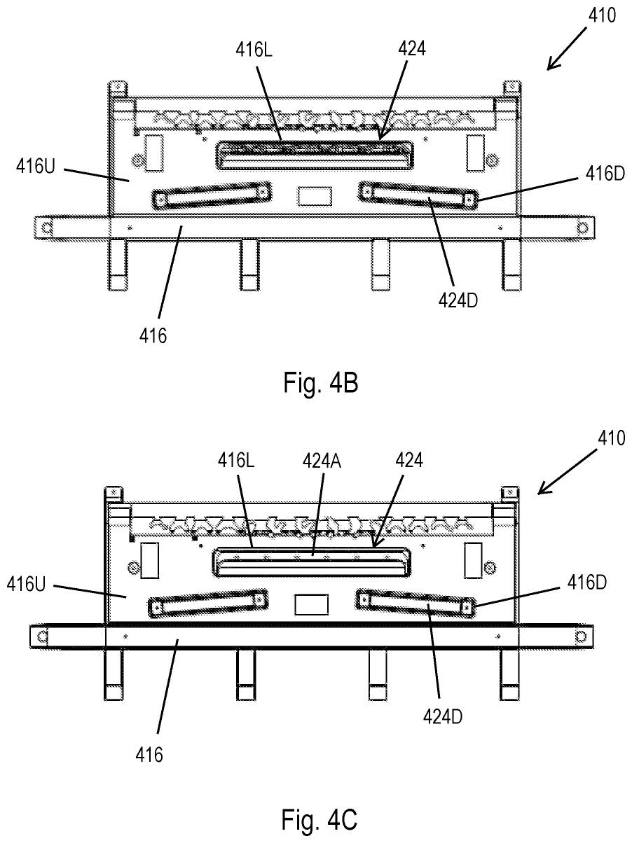

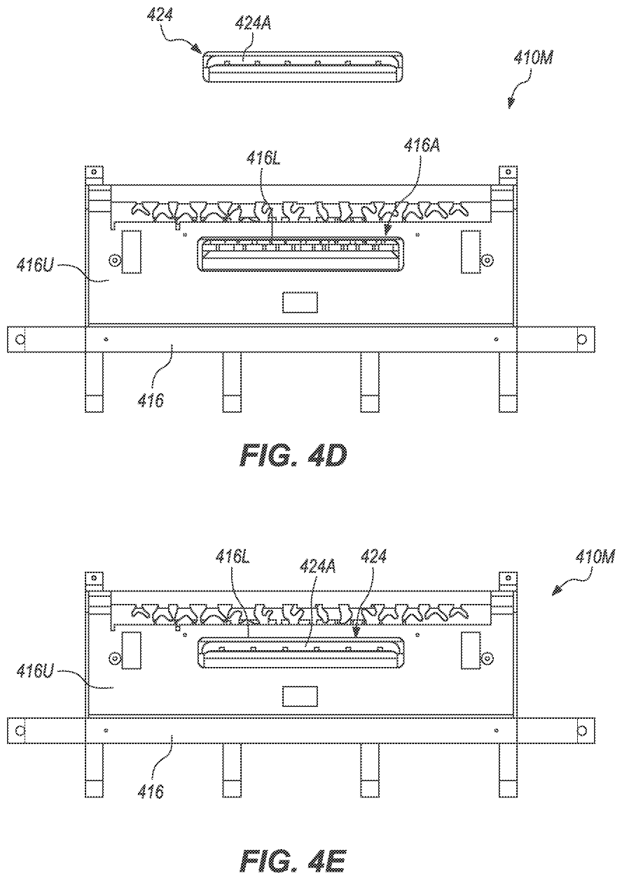

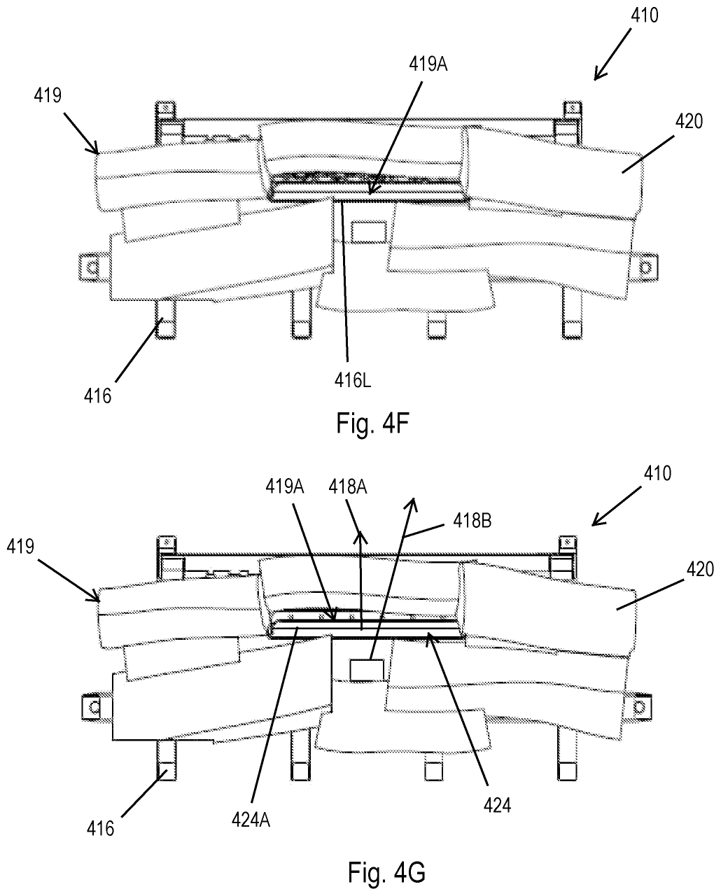

It is appreciated, as noted above, that the electric fireplace 310 can include multiple generator light sources for purposes of generating flame light that is directed away from the log assembly 319 in the first direction 318A through the first assembly opening 319A and in the second direction 318B through the second assembly opening 319B. For example, as described in detail herein below, FIGS. 4A-4G illustrate and describe embodiments of the electric fireplace that include a separate generator light source that is configured to generate flame light and direct the flame light away from the log assembly 319 in the first direction 318A through the first assembly opening 319A, which can be used in conjunction with the generator light source 324A that is configured to generate flame light and direct the flame light in the second direction 318B through the second assembly opening 319B.

FIG. 4A is a partially exploded top view illustration of a portion of still another embodiment of the electric fireplace 410. In particular, FIG. 4A illustrates a grate 416, and a portion of a flame generator 424 that is configured to generate the simulated flame 18 (illustrated in FIG. 1), that form a portion of the electric fireplace 410. It is appreciated that the electric fireplace 410 can include various other components such as shown and described in relation to the embodiment illustrated in FIG. 1. For example, as noted, the electric fireplace 410 can further include a generator light source 324A (illustrated in FIG. 3I) that is configured to generate flame light and direct the flame light away from the log assembly 419 (illustrated in FIG. 4F) in the second direction 318B (illustrated in FIG. 3I) through the second assembly opening 319B (illustrated in FIG. 3I). Alternatively, generator light source 324A of FIG. 3I can be designed with the LED array and without the rotating reflector.

As with previous embodiments, the grate 416 is configured to support a simulated log assembly 419 (illustrated in FIG. 4F) including a plurality of simulated logs 420 (illustrated in FIG. 4F) above the base panel 30 (illustrated in FIG. 1) of the fireplace housing 12 (illustrated in FIG. 1). More specifically, in certain such embodiments, the log assembly 419 and/or the plurality of simulated logs 420 are mounted on top of and/or fixedly secured to the grate 416. For example, in some embodiments, the log assembly 419 and/or the plurality of simulated logs 420 are fixedly secured to the grate 416, e.g., with one or more log attachers (not shown). Alternatively, in one embodiment, the log assembly 419 and/or the plurality of simulated logs 420 can be integrally formed with the grate 416. Still alternatively, in another embodiment, the log assembly 419 and/or the plurality of simulated logs 420 can be simply mounted and/or positioned on top of the grate 416 without being secured to the grate 416.

As above, the grate 416 can have any suitable design and/or can be formed from any suitable materials.

In certain embodiments, at least a portion of the flame generator 424 is supported by, coupled to, embedded into, and/or positioned substantially adjacent to an upper surface 416U of the grate 416. As shown in the embodiment illustrated in FIG. 4A, the grate 416 can include one or more (e.g., a plurality of) grate recesses 416A (or apertures) that are formed along and/or into the upper surface 416U of the grate 416. In particular, the plurality of grate recesses 416A are configured to receive and retain inserts that can include different components of the flame generator 424 and/or other light sources. In various embodiments, the grate recesses 416A can include a first recess 416L that is configured to receive and retain a first insert in the form of a generator light source 424A, and one or more second recesses 416D (two are illustrated in FIG. 4A) that are configured to receive and retain one or more second inserts 424D.

In many embodiments, as noted, the first insert can be a generator light source 424A that is selectively received and retained within the first recess 416L (also referred to herein as a “lighting recess”), and that is configured to generate flame light that is directed away from the log assembly 419 in a first flame direction 418A (illustrated in FIG. 4G, and also sometimes referred to herein simply as a “first direction”) through a first (upper, center) assembly opening 419A (illustrated in FIG. 4F) formed into the log assembly 419 (e.g., between one or more of the simulated logs 420 of the log assembly 419). In this implementation, the light source 424A can include an array of spaced apart LEDs (e.g., six are illustrated).

In some embodiments, the second inserts 424D can be provided in the form of one or more deflector elements that are selectively received and retained within the second recesses 416D (also sometimes referred to as “deflector recesses”), and that are configured to deflect at least a portion of the flame light from the generator light source 424A. With such design, the flame light generated from the generator light source 424A can be directed and/or deflected in a generally upward direction away from the grate 416. Alternatively, the flame generator 424 can have a different design. For example, in some non-exclusive alternative embodiments, the flame generator 424 can be configured without the one or more deflector elements and/or without the one or more deflector recesses formed along and/or into the upper surface 416U of the grate 416. Still alternatively, the second inserts 424D can be light sources that can be positioned directly below one or more of the simulated logs 420 of the log assembly 419 to provide a glowing effect for the simulated logs 420.

Additionally, in certain embodiments, as illustrated and described in greater detail herein below, the flame generator 424 is designed and positioned to direct light towards the logs 420.

In another implementation, the flame generator 424 is designed and positioned so at least (i) a first portion of the light for the simulated flame 18 is directed away from the flame generator 424 and the log assembly 419 in the first flame direction 418A through the first (upper, center) assembly opening 419A formed into the log assembly 419; and (ii) a second portion of the light for the simulated flame 18 away from the flame generator 424 and toward the second inserts 424D, e.g., the deflector elements, before the light is redirected away from the log assembly 419 in a second flame direction 418B that is different than the first direction 418A through the first assembly opening 419A formed into the log assembly 419. Although the first portion of the light for the simulated flame 18 and the second portion of the light for the simulated flame 18 are both directed through the first assembly opening 419A, the first direction 418A and the second direction 418B are still different from one another based on the positioning of the generator light source 424 and the second inserts 424D, e.g., deflector elements, relative to the first assembly opening 419A. More particularly, the first direction and the second direction are different angular directions relative to one another (although there may be some overlap) due to the different positions of the generator light source 424 and the second inserts 424D relative to the first assembly opening 419A.

As noted, the generator light source 424A is configured to generate the flame light. Additionally, the generator light source 424A can be designed and/or positioned to direct at least the second portion of the flame light toward the second inserts 424D, e.g., deflector elements, as well as directing the first portion of the flame light in a generally upward direction through the first assembly opening 419A without being first directed toward the deflector elements. With such design, the flame generator 424 is able to direct the first portion of the flame light from the generator light source 424A in the first direction 418A directly through the first assembly opening 419A, as well as the second portion of the flame light that is deflected by the deflector elements in the second direction 418B through the first assembly opening 419A to provide the desired three-dimensional flame effect for the simulated flame 18.

In one alternative embodiment, the generator light source 424A can be positioned within the grate 416 rather than being received and retained within the lighting recess 416L (or aperture), and the flame light from the generator light source 424A can be directed in a generally upward direction through the lighting recess 416L (or aperture) to provide the desired three-dimensional flame effect for the simulated flame 18.

The generator light source 424A can have any suitable design. For example, in one non-exclusive embodiment, the generator light source 424A includes a strip (or array) of LED lights that are coupled to one another, and that are positioned and/or oriented such that at least a portion of the light from the LED lights is directed toward the log assembly 419 and/or the second inserts 424D, e.g., the deflector elements. More specifically, in such embodiment, the generator light source 424A can include a flat, PCB board upon which is mounted an LED panel having one or more LED light bulbs. It is appreciated that the use of LED light bulbs makes it generally unnecessary to access the generator light source 424A as the LED light bulbs have a very long life span and do not need to be regularly replaced. Alternatively, the generator light source 424A can have another suitable design, e.g., can include other types of light bulbs or another type of light source.

Additionally, in certain embodiments, as illustrated, the flame generator 424 can further incorporate a shield 424S that is coupled to the generator light source 424A so that light from the generator light source 4242A is not directed in any undesired directions, e.g., outwardly directly toward the user or consumer. With such design, the overall three-dimensional flame effect can be enhanced as the user or consumer cannot directly see the light from the generator light source 424A when viewing the simulated flame 418 of the electric fireplace 410 in a typical manner

Further, the generator light source 424A can be positioned in any suitable manner relative to the second inserts 424D, e.g., the deflector elements, and the log assembly 419 to generate the desired three-dimensional flame effect. For example, in one embodiment, the generator light source 424A can be positioned slightly behind and somewhat between the second inserts 424D and substantially between two or more of the simulated logs 420 of the log assembly 419. With such design, the generator light source 424A, in conjunction with the deflector elements, can be utilized to illuminate the space between the simulated logs 420. Moreover, in some embodiments, the generator light source 424A can be programmed to undulate and/or pulse, such as being sequenced to simulate a flame and/or follow one or more other features or components of the electric fireplace 410.

In one embodiment, the controller 28 (illustrated in FIG. 1) can be configured to control at least a timing, a pulsing and/or a magnitude of the light being generated by the generator light source 424A to more effectively generate a flickering effect for the three-dimensional flame.

The second inserts 424D, e.g., the deflector elements, are configured to deflect at least a portion of the flame light from the generator light source 424A away from the grate 416 and/or the log assembly 419 in the second direction 418B through the first assembly opening 419A. The design of the deflector elements can be varied to suit the requirements of the electric fireplace 410. In one non-exclusive embodiment, the deflector elements include an optical surface that is configured and/or oriented to receive a portion of the flame light from the generator light source 424A and deflect such portion of the flame light in a generally upward and/or angled direction away from the grate 416 and/or the log assembly 419 in the second direction 418B through the first assembly opening 419A. Alternatively, the deflector elements can have another suitable design and/or can be positioned in another suitable manner. Still alternatively, as noted above, in some embodiments, the flame generator 424 can be designed without the deflector elements and the simulated logs 420 of the log assembly 419 can be configured to provide desired deflection of light from the generator light source 424A to help enhance the desired three-dimensional flame effect. For example, in one embodiment, one or more of the simulated logs 420 can be partly or fully formed from opaque materials (e.g., foam, pulp, paper, cement, etc.) that function to reflect and/or absorb light from the generator light source 424A so that the light is directed in the second direction 418B through the first assembly opening 419A.

FIG. 4B is a simplified top view illustration of a portion of the electric fireplace 410 illustrated in FIG. 4A. In particular, FIG. 4B is a simplified top view illustration of the grate 416, including the first recess 416L, e.g., the lighting recess, and the second recesses 416D, e.g., the deflector recesses 416D or other lighting recesses, that are formed into the upper surface 416U of the grate 416; and the second inserts 424D, e.g., the deflector elements or other light sources, of the flame generator 424 that are positioned in the second recesses 416D. As illustrated, the generator light source 424A has not yet been positioned within the first recess 416L. It is appreciated that in such configuration, i.e. without the generator light source 424A positioned within the first recess 416L, flame light for the simulated flame 18 (illustrated in FIG. 1) can be directed in a generally upward direction through the lighting recess 416L (or aperture) from a generator light source, such as the generator light source 324A (illustrated, for example, in FIG. 3I), positioned within the grate 416.

FIG. 4C is a simplified top view illustration of the portion of the electric fireplace 410 illustrated in FIG. 4A. In particular, FIG. 4C is a simplified top view illustration of the grate 416 and the flame generator 424 illustrated in FIG. 4A. As illustrated in FIG. 4C, the generator light source 424A of the flame generator 424 is positioned and/or retained within the first recess 416L formed into the upper surface 416U of the grate 416, and the second inserts 424D, e.g., the deflector elements or other light sources, are positioned and/or retained within the second recesses 416D formed into the upper surface 416U of the grate 416.

FIG. 4D is a partially exploded top view illustration of a portion of a modified version of the electric fireplace 410M illustrated in FIG. 4A. FIG. 4D again illustrates the grate 416, and a portion of the flame generator 424 that is configured to generate the simulated flame 18 (illustrated in FIG. 1), that form a portion of the electric fireplace 410M. Additionally, as with previous embodiments, the grate 416 is again configured to support the simulated log assembly 419 (illustrated in FIG. 4F) including the plurality of simulated logs 420 (illustrated in FIG. 4F) above the base panel 30 (illustrated in FIG. 1) of the fireplace housing 12 (illustrated in FIG. 1).

As shown in FIG. 4D, the flame generator 424 is somewhat similar to what was illustrated and described in the embodiment shown in FIG. 4A. For example, as illustrated, the flame generator 424 again includes the generator light source 424A that is configured to generate flame light, and the first recess 416L (or aperture) formed along and/or into the upper surface 416U of the grate 416 that is configured to receive and retain the generator light source 424A. However, in this modified embodiment, the flame generator 424 does not further include the second inserts, e.g., the one or more deflector elements or other light sources, and/or the one or more second recesses that are included in the embodiment of FIG. 4A. Rather, in this embodiment, one or more of the simulated logs 420 can be formed from opaque materials (e.g., foam, pulp, paper, cement, etc.) that function to reflect and/or absorb light from the generator light source 424A so that the light is directed in a second flame direction 418B (illustrated in FIG. 4G, and also sometimes referred to herein simply as a “second direction”) at the log assembly and/or through the first assembly opening 419A (illustrated in FIG. 4F).

Thus, with this design, the flame generator 424 is designed and positioned to direct at least a first portion of the light from the flame generator 424 at and through the log assembly 419 in a first flame direction 418A (illustrated in FIG. 4G, and also sometimes referred to herein simply as a “first direction”). Further, a second portion of the light from the flame generator 424 is directed toward the simulated logs 420 that redirect the light away from the log assembly 419 in the second flame direction 418B that is different than the first direction 418A through the first assembly opening 419A formed into the log assembly 419 (and/or through the logs 420). Although the first portion of the light for the simulated flame 18 and the second portion of the light for the simulated flame 18 are both directed through the first assembly opening 419A (or the logs 420), the first direction 418A and the second direction 418B are still different from one another based on the positioning of the generator light source 424 and the simulated logs 420 relative to the first assembly opening 419A. More particularly, the first direction and the second direction are different angular directions relative to one another (although there may be some overlap) due to the different positions of the generator light source 424 and the simulated logs 420 relative to the first assembly opening 419A. Accordingly, the flame generator 424 is able to direct the first portion of the flame light from the generator light source 424A in the first direction 418A directly through the first assembly opening 419A, as well as the second portion of the flame light that is deflected by the simulated logs 420 in the second direction 418B through the first assembly opening 419A to further enhance the desired three-dimensional flame effect for the simulated flame 18.

The generator light source 424A can be substantially identical to the embodiment illustrated in FIG. 4A. Accordingly, the generator light source 424A will not be described again in detail. Further, in some embodiments, the generator light source 424A can again be programmed to undulate and/or pulse, such as being sequenced to simulate a flame and/or follow one or more other features or components of the electric fireplace 410, in order to further enhance the three-dimensional flame effect. In one embodiment, the controller 28 (illustrated in FIG. 1) can again be configured to control at least a timing, a pulsing and/or a magnitude of the light being generated by the generator light source 424A to more effectively generate a flickering effect for the three-dimensional flame.

FIG. 4E is a simplified top view illustration of the portion of the modified electric fireplace 410M illustrated in FIG. 4D. In particular, FIG. 4E is a simplified top view illustration of the grate 416 and the flame generator 424 illustrated in FIG. 4D. As illustrated in FIG. 4E, the generator light source 424A of the flame generator 424 is positioned and/or retained within the first recess 416L formed into the upper surface 416U of the grate 416.

FIG. 4F is a simplified top view illustration of a portion of the electric fireplace 410 illustrated in FIG. 4A and/or the modified electric fireplace 410M illustrated in FIG. 4D. In particular, FIG. 4F is a simplified top view illustration of the grate 416 and the log assembly 419, including the plurality of simulated logs 420, that is mounted on top of, fixedly secured to, and/or integrally formed with the grate 416. Additionally, FIG. 4F further illustrates the first (upper, central) assembly opening 419A that is formed into the log assembly 419, i.e. between two or more of the simulated logs 420 of the log assembly 419.

As shown in FIG. 4F, the generator light source 424A (illustrated in FIG. 4A) has not yet been positioned within the first recess 416L. It is appreciated that in such configuration, i.e. without the generator light source 424A positioned within the first recess 416L, flame light for the simulated flame 18 (illustrated in FIG. 1) can be directed in a generally upward direction through the first recess 416L (or aperture) from a generator light source, such as the generator light source 324A (illustrated, for example, in FIG. 3I), positioned within the grate 416.

FIG. 4G is a simplified top view illustration of a portion of the electric fireplace 410 illustrated in FIG. 4A and/or the modified electric fireplace 410M illustrated in FIG. 4D. In particular, FIG. 4G is a simplified top view illustration of the grate 416 and the log assembly 419, including the plurality of simulated logs 420, that is mounted on top of, fixedly secured to, and/or integrally formed with the grate 416. Additionally, FIG. 4G further illustrates the generator light source 424A of the flame generator 424, which can work in conjunction with the second inserts 424D (illustrated in FIG. 4A), e.g., deflector elements, in certain embodiments, and/or which works in conjunction with the reflective design of one or more of the simulated logs 420 in other embodiments, to direct the flame light from the generator light source 424A in both the generally upward first direction 418A and the more angular second direction 418B through the first (upper, central) assembly opening 419A and/or through the logs 420.

As utilized herein, the simulated flame 18 (illustrated in FIG. 1) being projected and/or directed away from the log assembly 419 in the first direction 418A and/or the second direction 418B is intended to signify general ranges of direction where light, as part of the simulated flame 18, is directed in a range of angles through the first assembly opening 419A. More specifically, it is appreciated that the general direction and/or range of angles for the first direction 418A and/or the second direction 418B is defined by the specific size and shape of the first assembly opening 419A, as well as the positioning of the generator light source 424A and the second inserts 424D, e.g., deflector elements, (and/or the reflecting simulated logs 420) relative to the first assembly opening 419A. For example, in certain non-exclusive embodiments, the first assembly opening 419A can be sized and shaped such that at least a portion of the simulated flame 18 can be projected through the first assembly opening 419A, in either the first direction 418A or the second direction 418B, at an angular range of between approximately 15 degrees and 45 degrees. In one specific non-exclusive embodiment, the first assembly opening 419A can be sized and shaped such that the at least a portion of the simulated flame 18 can be projected through the first assembly opening 419A, in either the first direction 418A or the second direction 418B, at an angular range of approximately 33 degrees. In other embodiments, the first assembly opening 419A can be sized and shaped such that the at least a portion of the simulated flame 18 can be projected through the first assembly opening 419A, in either the first direction 418A or the second direction 418B, at an angular range of approximately 15 degrees, 20 degrees, 25 degrees, 30 degrees, 35 degrees, 40 degrees, 45 degrees or 50 degrees. Alternatively, in still other embodiments, the first assembly opening 419A can be sized and shaped such that the at least a portion of the simulated flame 18 can be projected through the first assembly opening 419A, in either the first direction 418A or the second direction 418B, at an angular range of greater than approximately 45 degrees or less than approximately 15 degrees.

It is further appreciated that the specific range of angles that the flame light is directed through the first assembly opening 419A (and/or the logs 420) can be different for flame light directed by the generator light source 424A in the first direction 418A directly through the first assembly opening 419A, and the flame light from the generator light source 424A that is reflected off of the second inserts 424D, e.g., the deflector elements, before being directed in the second direction 418B through the first assembly opening 419A. Stated in another manner, what constitutes the first direction 418A for the flame light being directed through the first assembly opening 419A for flame light directed by the generator light source 424A directly through the first assembly opening 419A, can be somewhat different than the flame light from the generator light source 424A that is reflected off of the second inserts 424D before being directed in the second direction 418B through the first assembly opening 419A.

FIGS. 5A-5K are a set of illustrations showing one representative embodiment of a method of installation of the electric fireplace 10.

Initially, FIG. 5A is an illustration demonstrating installation of the electrical insert 40 into the base opening 230A of the base panel 30. More specifically, FIG. 5A illustrates a plurality of insert attachers 550 that can be utilized to effectively secure the electrical insert 40 within the base opening 230A of the base panel 30. The electric fireplace 10 can include any suitable number and design of insert attachers 550. For example, in one embodiment, as shown in FIG. 5A, the electric fireplace 10 can include four screw-type insert attachers 550 for purposes of effectively securing the electrical insert 40 within the base opening 230A of the base panel 30. Alternatively, the electric fireplace 10 can include greater than four or fewer than four insert attachers 550, and/or the insert attachers 550 can have another suitable design.

Additionally, FIG. 5A further illustrates an embodiment of the electrical insert 40, including the heater assembly 26 and the controller 28 (with printed control board assembly (PCBA)), with the insert cover 244 positioned on top of the electrical insert 40. As noted above, the heater assembly 26 and the controller 28 can have any suitable design. Further, as shown, the controller 28 can include a control panel 528A that enables the user to control the various functions of the electric fireplace 10, e.g., the power, the heat, the light/flames, etc.

FIG. 5B is a front perspective view illustration of the electric fireplace 10 with the electrical insert 40 having been installed and/or embedded into the base panel 30, i.e. into the base opening 230A (illustrated in FIG. 2), and the side panels 34 also having been installed within the structural opening 211A in the cabinet 11.

With the design as described herein, the configuration of the electrical insert 40 being embedded into the base panel 30 will allow for more flexibility and increased efficiencies for manufacturing hub diversification, since only the base module, i.e. the electrical insert 40 embedded into the base panel 30, would need to come from a certified insert supplier, i.e. an electrical factory.

FIG. 5C is a rear perspective view illustration of the electric fireplace 10, as the front frame 236 is being installed within the structural opening 211A of the cabinet 11. Additionally, FIG. 5C illustrates a plurality of frame attachers 552 that can be utilized to secure the front frame 236 within the structural opening 211A of the cabinet 11. The electric fireplace 10 can include any suitable number and design of frame attachers 552. For example, in one embodiment, as shown in FIG. 5C, the electric fireplace 10 can include six screw-type frame attachers 552 for purposes of effectively securing the front frame 236 within the structural opening 211A of the cabinet 11. Alternatively, the electric fireplace 10 can include greater than six or fewer than six frame attachers 552, and/or the frame attachers 552 can have another suitable design.

Additionally, FIG. 5C also illustrates at least a portion of the electrical connection assembly 549 that is utilized to provide necessary power to the various electrical components of the electric fireplace 10.

FIG. 5D is a front perspective view illustration of the electric fireplace 10, with the electrical insert 40 having been installed and/or embedded into the base panel 30, i.e. into the base opening 230A (illustrated in FIG. 2), and the side panels 34 and the front frame 236 also having been installed within the structural opening 211A in the cabinet 11.

FIG. 5E is a front perspective view illustration of the electric fireplace 10, with the grate 16, the simulated logs 20, the light source 22 (illustrated in FIG. 1) and the flame generator 24 in the process of being installed above the base module, i.e. the electrical insert 40 and the base panel 30.

FIG. 5F is another front perspective view illustration of the electric fireplace 10, after the grate 16, the simulated logs 20, the light source 22 (illustrated in FIG. 1) and the flame generator 24 have been installed above the base module, i.e. the electrical insert 40 and the base panel 30.

FIG. 5G is a rear perspective view illustration of the electric fireplace 10, with the grate 16, the simulated logs 20, the light source 22 (illustrated in FIG. 1) and the flame generator 24 being secured in place above the base module, i.e. the electrical insert 40 and the base panel 30, with a plurality of grate attachers 554. The electric fireplace 10 can include any suitable number and design of grate attachers 554. For example, in one embodiment, as shown in FIG. 5G, the electric fireplace 10 can include two screw-type grate attachers 554 for purposes of effectively securing the grate 16, the simulated logs 20, the light source 22 and the flame generator 24 in place above the base module. Alternatively, the electric fireplace 10 can include greater than two or fewer than two grate attachers 554, and/or the grate attachers 554 can have another suitable design.

FIG. 5H is a rear perspective view illustration of the electric fireplace 10, further illustrating a portion of the electrical connection assembly 549 that can be utilized to selectively provide power to the various electrical components of the electric fireplace 10. More particularly, FIG. 5H illustrates that the electrical connection assembly 549 can include the first electrical connection port 549A, the second electrical connection port 549B (e.g., a low voltage DC port such as a USB port), the first electrical cable assembly 549C (e.g., the AC external power cord with corresponding connector(s)), the second electrical cable assembly 549D (e.g., the low voltage DC cable such as a USB cable with corresponding connector(s), also shown in the enlarged view), and the third electrical connection port 549E (e.g., a low voltage DC port such as a USB port, also shown in an enlarged view). As such, power can be supplied from the external power source 42 (illustrated in FIG. 1) to the electrical insert 40, i.e. the heater assembly 26 (illustrated in FIG. 5A) and the controller 28 (illustrated in FIG. 5A), and then from the electrical insert 40 to the grate 16, i.e. to the light source 22 (illustrated in FIG. 1) and/or the flame generator 24 (illustrated in FIG. 5E).

FIG. 5I is a rear perspective view illustration of the electric fireplace 10, as the back panel 32 is about to be installed within the structural opening 211A of the cabinet 11. Additionally, FIG. 5I further illustrates that in one embodiment, the back panel 30 can be mounted on a segmented substrate 232A to enable the back panel 32 to be foldable. As noted above, with such design, the back panel 32 can be packed more compactly for purposes of shipping and/or storage.

FIG. 5J is another rear perspective view illustration of the electric fireplace 10, during the process of installing the back panel 32 within the structural opening 211A of the cabinet 11. In particular, FIG. 5J illustrates a plurality of panel attachers 556 that can be utilized for installing and securing the back panel 32 within the structural opening 211A of the cabinet 11. The electric fireplace 10 can include any suitable number and design of panel attachers 556. For example, in one embodiment, as shown in FIG. 5J, the electric fireplace 10 can include four screw-type panel attachers 556 for purposes of effectively securing the back panel 32 within the structural opening 211A of the cabinet 11. Alternatively, the electric fireplace 10 can include greater than four or fewer than four panel attachers 556, and/or the panel attachers 556 can have another suitable design.

Additionally, FIG. 5J also illustrates the first electrical cable assembly 549C that is usable for connecting the electric fireplace 10 to the external power source 42 (illustrated in FIG. 1), such as an electrical outlet.

Finally, FIG. 5K is a front perspective view illustration of the electric fireplace 10, after all of the components of the electric fireplace 10 have been installed and/or secured within the structural opening 211A of the cabinet 11. More specifically, FIG. 5K illustrates the electric fireplace 10 after the base panel 30, the side panels 34, the front frame 236, the electrical insert 40, i.e. the heater assembly 26 and the controller 28 in this embodiment, the grate 16, the simulated logs 20, the light source 22 (illustrated in FIG. 1), the flame generator 24, and the back panel 32 have been installed and/or secured within the structural opening 211A of the cabinet 11.

Additionally, or in the alternative, it is appreciated that, in some embodiments, the electric fireplace 10 can be configured without the back panel 32 and/or the front frame 236. For example, in certain such embodiments, the electric fireplace 10 can be a two-sided fireplace, wherein the viewing area 14 is viewable from either side of the electric fireplace 10. In such embodiments, the electric fireplace 10 would be configured and/or installed without the back panel 32, and could also include a separate front frame 236 on either side.

In summary, the objective of this construction of the electric fireplace 10 is to embed the insert components into the fireplace housing 12 (or mantel) parts to make the combined packaging the same size as a typical mantel-only box size. Additionally, the construction will also improve the aesthetic appearance of the overall electric fireplace 10 as there are no longer height or shape restrictions for the mantel opening. Further, the appearance of the simulated flame 18 will be improved due to increased depth and more backdrop options. Moreover, backdrop depth is no longer limited by insert enclosure size, so heavier textures can be used with larger flame projection. Different backdrop styles and/or reversible backdrops can also be provided for different options at the user level.

Additionally, since there are no limitations on the height of the structural opening 211A, e.g., within the cabinet 11, or the size and shape of the back panel 32 and/or the simulated logs 20, more standardized structural features can be utilized. For example, a standardized 26-inch part can be utilized within 23-inch, 26-inch or 28-inch structural openings; and a standardized 36-inch part can be utilized within 33-inch and 36-inch structural openings. Different heights, shapes and simulated logs can then be utilized to differentiate the overall design.

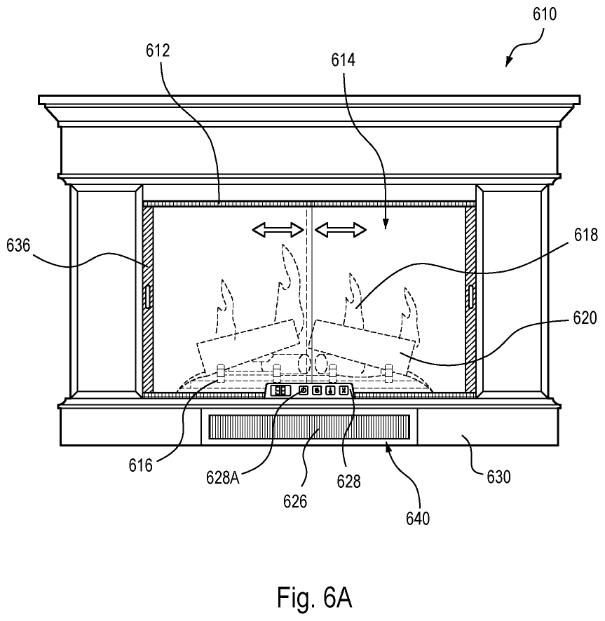

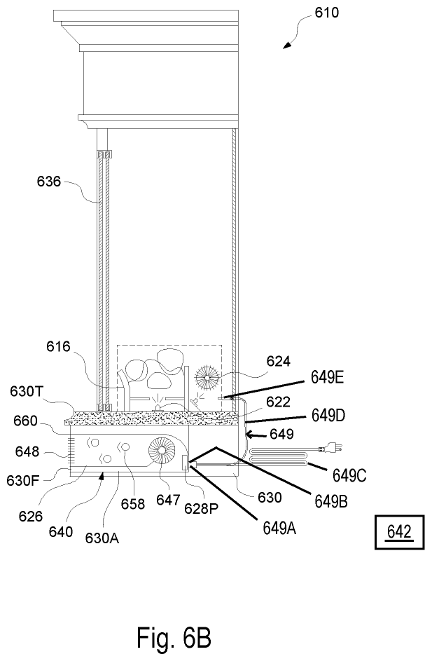

FIG. 6A is a simplified front view illustration of another embodiment of the electric fireplace 610. As illustrated, the electric fireplace 610 is somewhat similar in design to those embodiments illustrated and described herein above. For example, in this embodiment, the electric fireplace 610 again includes a fireplace housing 612, a viewing area 614, a grate 616, a simulated flame 618, simulated logs 620, and a light source 622 (illustrated in FIG. 6B) and/or a flame generator 624 (illustrated more clearly in FIG. 6B) that are substantially similar to one or more embodiments illustrated and described herein above. Additionally, the electric fireplace 610 further includes an electrical insert 640 that includes a heater assembly 626, and at least portion of a controller 628, that are somewhat similar to what was illustrated and described in previous embodiments.

However, in this embodiment, the base panel 630 of the fireplace housing 612 is somewhat different than in the previous embodiments. Referring briefly to FIG. 6B, FIG. 6B is a cross-sectional side view illustration of the electric fireplace 610 illustrated in FIG. 6A taken on line B-B. In this embodiment, as shown in FIG. 6B, the electrical insert 640 is positioned to be more fully embedded within the base opening 630A of the base panel 630, i.e. such that no part of the electrical insert 640 extends and/or protrudes above a top surface 630T of the base panel 630. With such design, the electric fireplace 610 can have any even more compact overall design during use, as well as for purposes of packaging, shipping and storage.

Additionally, as such, the heater assembly 626 also has a somewhat modified design in comparison to the embodiments described in detail herein above. As with the previous embodiments, the heater assembly 626 is configured to provide heated air which can be directed in a generally outward direction away from the electric fireplace 610. More particularly, as shown in FIG. 6B, the heater assembly 626 includes a fan or blower 647 that blows hot air generated by one or more heating elements 658 through a grill cover 648 (heat vents) into the area surrounding the electric fireplace 610. In this embodiment, the grill cover 648 is positioned to extend and/or direct the heated air through a front opening 660 in the base panel 630. Stated in another manner, the heated air is directed away from a front surface 630F of the base panel 630, i.e. through the grill cover 648, rather than the top surface 630T of the base panel 630 as in previous embodiments.

Moreover, in this embodiment, the controller 628 includes components that are included within the electrical insert 640 as well as components that can be alternatively coupled to the grate 616. For example, in one non-exclusive embodiment, the controller 628 can include a main PCBA 628P that is coupled to and/or integrated within the electrical insert 640, and a control panel 628A (illustrated in FIG. 6A) that is coupled to the grate 616 instead of being directly coupled to the body of the electrical insert 640, as was shown in the previous embodiments. With such design, the control panel 628A will be easily accessible to the user, as the user will merely have to open the front frame 636, e.g., by sliding doors of the front frame 636 relative to one another. Alternatively, the control panel 628A can be coupled to and/or incorporated as part of the electrical insert 640, and a separate front opening (not shown) in the base panel 630 can be utilized to provide access to the control panel 628A by the user.

FIG. 6B further illustrates the various components of the electrical connection assembly 649 that can be used to provide the desired power to the electric fireplace 610. More specifically, FIG. 6B further illustrates (i) the first electrical cable assembly 649C that is electrically coupled between the main PCBA 628P of the electrical insert 640, via the first electrical connection port 649A in certain embodiments, and the power source 642; and (ii) the second electrical cable assembly 649D that is electrically coupled between the main PCBA 628P of the electrical insert 640, via the second electrical connection port 649B in certain embodiments, and the grate 616, via the third electrical connection port 649E, and thus the electrical components coupled thereto and/or incorporated therein. Thus, the electrical connection assembly 649 can be used for providing the necessary power to the electrical insert 640, as well as the necessary power and control between the electrical insert 640 and the grate 616, to effectively power one or more of the light source 622, the flame generator 624, the heater assembly 626 and the controller 628.

It is understood that although a number of different embodiments of the electric fireplace 10 have been illustrated and described herein, one or more features of any one embodiment can be combined with one or more features of one or more of the other embodiments, provided that such combination satisfies the intent of the present invention.

While a number of exemplary aspects and embodiments of the electric fireplace 10 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

A complete listing of all of the claims in the present Application is as follows:

1. An electric fireplace comprising:
a back panel;
a log assembly positioned in front of the back panel, the log assembly defining an assembly opening; and
a flame generator that directs light at the log assembly in both a first direction and a second direction that is different from the first direction to generate a three-dimensional simulated flame; wherein the flame generator includes a generator light source that generates flame light, and a reflective element that alternatively directs the flame light from the generator light source in both the first direction and the second direction; and wherein the light being directed in the first direction is directed through the assembly opening and through the log assembly, and the light being directed in the second direction is directed at the back panel.

2. The electric fireplace of claim 1 wherein the log assembly includes at least one simulated log.

3. The electric fireplace of claim 1 wherein the log assembly includes a plurality of simulated logs.

4. The electric fireplace of claim 3 wherein the plurality of simulated logs are positioned relative to one another to define the assembly opening.

5. The electric fireplace of claim 4 wherein the assembly opening is configured such that the first direction includes an angular range of between approximately 15 degrees and 45 degrees within which the light is directed through the assembly opening.

6. The electric fireplace of claim 5 wherein the log assembly further defines at least a portion of a second assembly opening; and wherein the light being directed in the second direction includes light being directed through the second assembly opening.

7. The electric fireplace of claim 6 wherein the second assembly opening is configured such that the second direction includes a second angular range of between approximately 25 degrees and 80 degrees within which the light is directed through the second assembly opening.

8. (canceled)

9. The electric fireplace of claim 1 wherein the reflective element is rotated with an element mover to alternatively direct the flame light from the generator light source in both the first direction and the second direction.

10. The electric fireplace of claim 9 wherein the reflective element includes a substantially cylindrical tube-shaped base.

11. The electric fireplace of claim 9 wherein the reflective element includes a plurality of reflective surfaces.

12. The electric fireplace of claim 1 further comprising a grate that is configured to support the log assembly, wherein the grate defines at least a portion of the assembly opening.

13. The electric fireplace of claim 12 wherein the flame generator is incorporated into the grate.

14. The electric fireplace of claim 13 wherein the log assembly is fixedly secured to the grate.

15. The electric fireplace of claim 9 further comprising a controller including a processor that is configured to control operation of the flame generator; wherein the controller is configured to control at least one of a timing, a pulsing and a magnitude of the light being directed by the flame generator.

16. (canceled)

17. A method of manufacturing an electric fireplace comprising:
a back panel;
providing a log assembly, the log assembly defining an assembly opening; and
directing light at the log assembly with a flame generator in both a first direction and a second direction that is different from the first direction to generate a three-dimensional simulated flame; wherein the flame generator includes a generator light source that generates flame light, and a reflective element that alternatively directs the flame light from the generator light source in both the first direction and the second direction; and wherein the light being directed in the first direction is directed through the assembly opening and through the log assembly, and the light being directed in the second direction is directed at the back panel.

18. The method of claim 17 wherein the step of providing includes the log assembly including at least one simulated log.

19. The method of claim 17 wherein the step of providing includes the log assembly including a plurality of simulated logs.

20. The method of claim 19 wherein the step of providing includes positioning the plurality of simulated logs relative to one another to define the assembly opening.

21. The method of claim 20 wherein the assembly opening is configured such that the first direction includes an angular range of between approximately 15 degrees and 45 degrees within which the light is directed through the assembly opening.

22. The method of claim 21 wherein the step of providing includes the log assembly further defining at least a portion of a second assembly opening; and wherein the step of directing includes directing light with the flame generator in the second direction through the second assembly opening.

23-64. (canceled)
